(19) United States
(12) Patent Application Publication
(10) Pub. No.: US 2026/0288840 A1
(43) Pub. Date: Sep. 24, 2026

(54) SYSTEM

(71) Applicant: SoftBank Group Corp., Tokyo (JP)

(72) Inventor: Hiroki SASAKIDO, Tokyo (JP)

(73) Assignee: SoftBank Group Corp., Tokyo (JP)

(21) Appl. No.: 19/568,893

(22) Filed: Mar. 17, 2026

(30) Foreign Application Priority Data
Mar. 19, 2025 (JP) 2025-045182

(51) Int. Cl. G06F 16/338; G06F 11/34; G06F 16/3329; G06F 21/62; G10L 15/22

(52) U.S. Cl. CPC G06F 16/338; G06F 11/3452; G06F 16/3329; G06F 21/6245; G10L 15/22

(57) ABSTRACT

A system includes a processor configured to: record, in a database used for centrally managing a plurality of information processing devices, information including a type, performance, and usage status for each of the plurality of information processing devices, analyze a context of an input prompt by using natural language processing techniques, and select, based on an analysis result of the context, at least one optimal information processing device or external function, generate, by using a generative AI model, an instruction for the selected at least one information processing device or external function, output the generated instruction to the selected at least one information processing device or external function, receive one or more results from the selected at least one information processing device or external function, evaluate a reliability and an accuracy of the one or more results, and integrate the one or more results based on the evaluation.

### CROSS-REFERENCE TO RELATED APPLICATION

This application is based on and claims priority under 35 USC 119 from Japanese Patent Application No. 2025-045182 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems that utilize multiple information processing devices and external functions, such as various AI engines and external APIs, suffer from several technical problems. First, in many cases, such systems do not centrally manage information on the types, performance characteristics, and usage status of the individual information processing devices. As a result, the system may select a suboptimal device or function for a given input prompt, leading to degraded processing efficiency, reduced accuracy, and inconsistent response quality.

Second, conventional systems often lack a mechanism for dynamically analyzing the context of an input prompt using natural language processing and, based on that analysis, automatically selecting an optimal combination of information processing devices and external functions. Without such a mechanism, prompt routing tends to be static or rule-based, making it difficult to adapt to diverse tasks and complex user requests. Third, even when multiple devices or external functions are used, conventional systems typically do not evaluate the reliability or accuracy of the individual results in a statistically rigorous manner, and do not properly integrate those results. Consequently, the final output may be unstable or biased by a single device, and the overall quality of the integrated result cannot be sufficiently improved.

Fourth, conventional systems frequently ignore a user's emotional state when generating responses. In particular, such systems often lack a function to analyze voice or text to infer the emotional state of the user and to adapt the content or style of the response based on the inferred emotion. This leads to responses that may be inappropriate for the user's current state, thereby reducing user satisfaction and, in some cases, impairing the effectiveness of support or communication tasks.

Therefore, there is a need for a system that centrally manages a plurality of information processing devices, selects an optimal device or external function according to the context of a prompt, statistically evaluates and integrates results, and further analyzes the user's emotional state to adjust the response, thereby improving the overall quality, reliability, and user experience of interactions.

### SUMMARY

To solve the above problems, the present invention provides a system comprising a processor, wherein the processor is configured to perform the following operations. The processor records, in a database used for centrally managing a plurality of information processing devices, information including a type, performance, and usage status for each of the information processing devices. By maintaining, in an integrated manner, data such as processing speed, accuracy, usage count, and last-used time, the system can manage a comprehensive profile of each device and thereby enable informed and adaptive selection based on up-to-date information.

The processor analyzes a context of an input prompt by using natural language processing techniques, and selects, based on an analysis result of the context, at least one optimal information processing device or external function. For example, the processor determines whether the prompt is a text, image, or other type of data, identifies the task category such as summarization, question answering, classification, or recognition, and then references the database to select the device or external function that is most suitable in terms of type and performance for that specific context.

The processor generates, by using a generative AI model, an instruction for the selected at least one information processing device or external function, outputs the generated instruction to the selected at least one information processing device or external function, receives one or more results from the selected at least one information processing device or external function, evaluates a reliability and an accuracy of the one or more results by using a statistical method, and integrates the one or more results based on the evaluation. Specifically, the processor may use statistical methods such as weighting based on confidence scores, aggregating multiple outputs, or applying Bayesian estimation or machine learning models to determine an integrated result with improved quality, thereby reducing the influence of outliers and increasing overall robustness.

Furthermore, the processor analyzes a user's emotional state through at least one of voice analysis and text analysis, and adjusts a response to the user based on an analysis result of the user's emotional state. For instance, the processor extracts acoustic features or linguistic features indicative of emotion, such as stress, satisfaction, or frustration, and modifies the tone, level of detail, or content of the response accordingly. In this way, the system can provide responses that are technically appropriate and also aligned with the user's emotional context.

According to these means, the system of the present invention can centrally manage multiple information processing devices, accurately select and instruct optimal devices or external functions according to the context of a prompt, statistically evaluate and integrate their outputs, and dynamically adapt responses to the user's emotional state, thereby improving the efficiency, reliability, and user satisfaction of information processing and interactive services.

The term “system” refers to an arrangement of hardware and software components including at least one processor and associated memory, storage, and interfaces, configured to execute the functions described in the claims.

The term “processor” refers to one or more hardware processing units, such as a central processing unit (CPU), graphics processing unit (GPU), digital signal processor (DSP), or dedicated accelerator, or a combination thereof, capable of executing instructions to perform the operations described in the claims.

The term “database” refers to any structured data storage mechanism, including but not limited to relational databases, NoSQL databases, key-value stores, or in-memory data structures, configured to store and retrieve information about the plurality of information processing devices.

The term “information processing device” refers to any computing entity, including local or remote servers, virtual machines, containers, modules, or specialized hardware, that performs one or more computational tasks such as natural language processing, image recognition, or data analysis in response to instructions.

The term “external function” refers to any functionality or service provided outside the local system, including external application programming interfaces (APIs), web services, cloud-based services, or third-party AI models, that can be invoked by the system to process data or perform a task.

The term “type” refers to a classification of an information processing device, including but not limited to processing modality (for example, natural language processing, image processing, speech processing), functional category (for example, summarization, translation, object detection), or other predefined attributes that characterize its processing capabilities. The term “performance” refers to quantitative or qualitative characteristics of an information processing device or external function, including but not limited to processing speed, throughput, latency, accuracy, precision, recall, or resource usage, which can be used to evaluate and compare devices.

The term “usage status” refers to operational information about an information processing device or external function, including but not limited to the number of times it has been used, the most recent time of use, error rates, current load, and historical usage patterns.

The term “prompt” refers to input data provided by or on behalf of a user or another system, including but not limited to text, audio, image, video, or structured data, which is processed to generate one or more responses or outputs.

The term “context of an input prompt” refers to information derived from the prompt and its surrounding conditions, including the content, format, language, intent, task type, domain, and any associated metadata, which is used to decide how to process the prompt.

The term “natural language processing techniques” refers to computational methods and algorithms for analyzing, understanding, or generating human language, including but not limited to tokenization, parsing, semantic analysis, intent recognition, classification, summarization, and machine translation.

The term “optimal information processing device or external function” refers to one or more information processing devices or external functions selected as most suitable for processing a given prompt based on criteria such as type, performance, usage status, and contextual requirements derived from the prompt.

The term “generative AI model” refers to a machine learning model, such as a neural network, trained to generate data or content, including but not limited to natural language text, instructions, or control parameters, in response to input conditions or prompts.

The term “instruction” refers to structured data or commands generated for an information processing device or external function, specifying how to process the prompt, including parameters, options, task descriptions, or operation sequences.

The term “result” refers to output data returned by an information processing device or external function in response to an instruction, including but not limited to text, labels, scores, structured data, or intermediate processing outcomes.

The term “reliability” refers to an assessment of trustworthiness or consistency of a result produced by an information processing device or external function, which may be based on historical performance, internal confidence scores, error rates, or statistical evaluation.

The term “accuracy” refers to a measure of correctness or closeness of a result to an expected or true value, and may be quantified using metrics such as precision, recall, F1 score, or other task-specific evaluation measures.

The term “statistical method” refers to any technique based on statistics used to evaluate, combine, or infer properties of results, including but not limited to weighting, averaging, hypothesis testing, confidence estimation, or probabilistic modeling.

The term “Bayesian estimation” refers to a statistical method that updates probability distributions of variables or hypotheses based on prior distributions and observed data using Bayes' theorem, and is applied to evaluate or integrate results.

The term “machine learning model” refers to a computational model trained on data to perform tasks such as prediction, classification, regression, or ranking, and includes models such as neural networks, decision trees, support vector machines, ensemble models, or probabilistic models.

The term “integrate” refers to the operation of combining two or more results from information processing devices or external functions into a single unified result, for example by aggregating, reconciling, or selecting elements based on reliability, accuracy, or other criteria.

The term “integrated result” refers to an output that is produced by combining multiple results from information processing devices or external functions according to a defined integration method, and that is provided as the final or intermediate outcome of processing.

The term “user's emotional state” refers to a psychological or affective condition of a user, such as happiness, sadness, anger, stress, satisfaction, or frustration, inferred from user data including voice or text.

The term “voice analysis” refers to the processing and analysis of audio signals of a user's speech to extract features such as pitch, tone, energy, speaking rate, or spectral characteristics, and to estimate the user's emotional state or other attributes.

The term “text analysis” refers to the processing and analysis of textual data produced by or associated with a user, including lexical, syntactic, semantic, or sentiment analysis, in order to infer the user's emotional state or other attributes.

The term “response” refers to information generated by the system and provided to the user or another system based on the results of processing the prompt and, optionally, the analyzed emotional state of the user, including but not limited to text messages, audio output, visual displays, or control signals.

The term “adjust a response” refers to modifying at least one aspect of the response, such as content, tone, style, length, level of detail, or modality, based on the analysis of the user's emotional state, performance metrics, or contextual information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

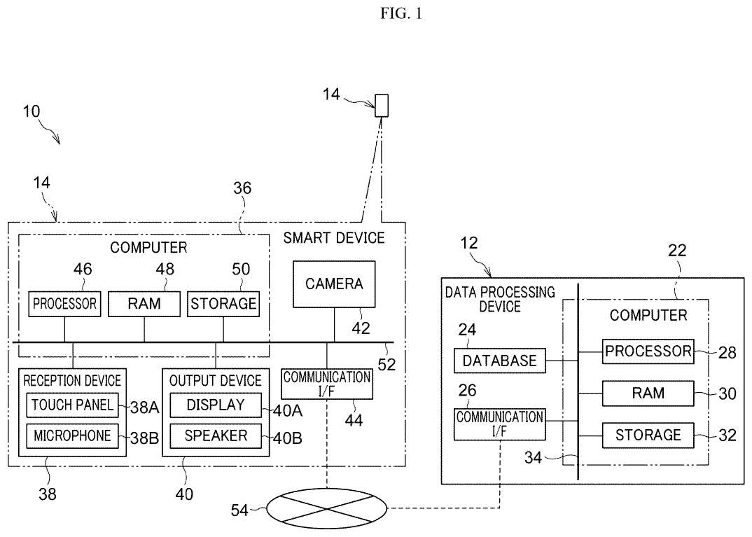

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

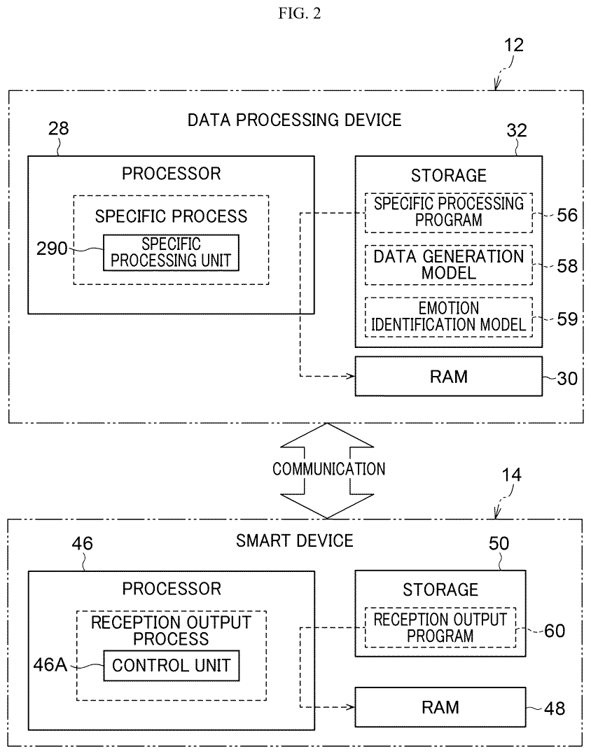

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional systems that execute tasks using a generative AI model in response to a prompt sentence, the overall computational workflow is often static and narrowly optimized. A typical system forwards every prompt sentence to a single fixed model or a small set of manually configured models without systematically considering heterogeneous processing resources, dynamic load conditions, or task-specific requirements. As a result, such systems frequently suffer from suboptimal latency, unnecessary computational cost, and degraded output quality when handling diverse prompt sentences and rapidly changing workloads.

In particular, existing orchestration mechanisms generally lack a structured way to (i) normalize and analyze the prompt sentence at a contextual level to derive explicit task requirements, (ii) evaluate multiple heterogeneous information processing elements and external function elements based on up-to-date operational performance information, and (iii) algorithmically select and drive an optimal generative AI model or model pipeline on a per-request basis. Without these capabilities, the system cannot effectively adapt to variations in task type (for example, summarization vs. translation), required output format, or reliability constraints, and must instead rely on coarse, manually tuned routing rules.

Furthermore, many existing systems either ignore or only superficially use operational performance data such as processing time, error occurrences, and user evaluations. Even when such data is logged, it is rarely fed back into the selection logic in a principled way. Consequently, the routing of prompt sentences does not improve over time, and the system cannot automatically adjust to hardware degradation, model updates, or changing user behavior. This leads to persistent inefficiencies and makes it difficult to maintain high-quality responses as models and infrastructure evolve.

Additionally, conventional architectures often do not integrate multiple generated results in a robust manner. When multiple models or processing paths are available, the system may arbitrarily choose one result without evaluating relative reliability and accuracy, or may lack mechanisms to validate that the generated output actually conforms to structural and formatting requirements specified in the prompt sentence. This can cause responses that are syntactically well-formed yet structurally unsuitable for downstream use, thereby limiting the practical utility of generative AI outputs in automated pipelines.

There is therefore a need for an improved computer-implemented system and method that (a) centrally manages heterogeneous information processing elements and external function elements, (b) performs contextual analysis and normalization of the prompt sentence to derive explicit requirement condition information, (c) computes, for each available processing element, a suitability index based on both static capability information and dynamic operational performance information, (d) uses this suitability index to select and drive an appropriate generative AI model or combination of models, and (e) evaluates, integrates, and feeds back generated results in a way that continuously improves routing accuracy and output quality. Such a system should concretely improve the functioning of the computer itself by optimizing resource utilization, reducing latency, enhancing reliability of outputs, and enabling adaptive, data-driven orchestration of generative AI processing across diverse hardware and software components.

The specific processing by the specific processing unit 290 of the data processing device 12 in Example 1 is realized by the following means.

The present invention provides a server comprising a processor configured to centrally manage a plurality of heterogeneous information processing elements and external function elements by using an information storage element that collectively records type information, processing capability information, usage state information, and operational performance information for the plurality of elements; acquire a prompt sentence from a user terminal, perform preprocessing on the prompt sentence including character code conversion, removal of unnecessary characters, and format normalization, and analyze contextual information of the prompt sentence by using a natural language processing technique to extract requirement condition information including at least a task type, an output format, and a constraint condition; calculate, for each of the plurality of information processing elements, a suitability index by performing weighted arithmetic on at least a processing speed index, an accuracy index, and a resource utilization index based on the requirement condition information and the information recorded in the information storage element, select, according to the suitability index, at least one information processing element and/or at least one external function element, and transmit processing request information including the prompt sentence and the requirement condition information to the selected element; cause a generative artificial intelligence model executed on the selected element to perform information processing including at least one of text generation processing, summarization processing, translation processing, question answering processing, and data analysis processing, acquire at least one processing result from the selected element, perform validation including inspection of output format conformity, language type, and satisfaction of structural requirements, calculate reliability and accuracy indices for the at least one processing result by using a statistical technique or a machine learning technique, and generate an integrated result by selecting or integrating the at least one processing result based on the reliability and accuracy indices; and format the integrated result into a data structure suitable for transmission and transmit the integrated result to the user terminal, while storing, in an anonymous manner, history information associated with the prompt sentence, the requirement condition information, the selected element, and the integrated result in a log storage element and retraining at least one of a task type discrimination model and a suitability index calculation model by using the history information so as to dynamically update weight coefficients used in the suitability index calculation. This enables the computer system to autonomously and continuously optimize the selection and orchestration of generative AI models and processing resources for each prompt sentence, thereby improving computational efficiency, reducing response time, enhancing reliability and structural conformity of generated outputs, and providing a concrete improvement in the functioning of the underlying computer technology.

The term “system” refers to a computer-implemented arrangement including at least one processor and one or more memory elements that cooperate to execute machine-readable instructions to perform the claimed functions.

The term “processor” refers to one or more hardware computation units, such as a central processing unit or a graphics processing unit, configured to execute instructions and perform arithmetic, logical, control, and input/output operations.

The term “information processing element” refers to a hardware and/or software component, such as a computing node, a model execution engine, or a service module, that is capable of performing data processing or computation in response to an input.

The term “external function element” refers to a processing resource or service, accessible over a communication network and implemented outside the local computing environment, that provides data processing, model inference, or other computational functionality through an interface.

The term “information storage element” refers to any memory structure, such as a database system or a persistent storage device, that is configured to record, maintain, and provide access to information used for managing and selecting information processing elements and external function elements.

The term “type information” refers to data describing a classification or category of an information processing element or an external function element, including but not limited to model family, task capability, interface protocol, or deployment environment.

The term “processing capability information” refers to data representing performance characteristics of an information processing element or an external function element, including at least throughput, accuracy, supported tasks, and resource requirements.

The term “usage state information” refers to data indicating a current or recent operational condition of an information processing element or an external function element, such as load level, queue length, availability, or error status.

The term “operational performance information” refers to time-varying metrics associated with actual execution of tasks by an information processing element or an external function element, including processing time, failure occurrences, and user evaluation indicators.

The term “use terminal” refers to a client-side computing device, such as a personal computer, a mobile device, or another user interface device, that transmits a prompt sentence to the server and receives a processing result.

The term “prompt sentence” refers to a text string or equivalent textual input provided by a user or another process, specifying a task, question, or instruction intended for processing by a generative artificial intelligence model.

The term “preprocessing” refers to a set of operations applied to the prompt sentence before further analysis or model input, including at least character code conversion, removal of unnecessary or invalid characters, and normalization of formatting.

The term “contextual information” refers to information derived from the content and structure of the prompt sentence, including implicit or explicit intent, task type, required output style, and constraint conditions.

The term “natural language processing technique” refers to a computational method or algorithm for analyzing, understanding, or transforming human language text, including but not limited to tokenization, parsing, classification, and embedding-based analysis.

The term “requirement condition information” refers to structured data representing requirements derived from the prompt sentence, including at least a task type, an output format, and one or more constraint conditions such as length limits or style instructions.

The term “task type” refers to a classification of the processing requested by the prompt sentence, including but not limited to text generation, summarization, translation, question answering, or data analysis.

The term “output format” refers to a specified structure, layout, or representation of the processing result, such as plain text, list format, structured markup, machine-readable format, or any predefined template.

The term “constraint condition” refers to a rule, limitation, or preference relating to the processing or the result, including length constraints, language restrictions, style requirements, or timing constraints.

The term “processing speed index” refers to a numerical indicator of the expected or measured processing time or latency for an information processing element or an external function element to complete a task.

The term “accuracy index” refers to a numerical indicator of expected or measured correctness, fidelity, or quality of outputs generated by an information processing element or an external function element for one or more task types.

The term “resource utilization index” refers to a numerical indicator representing consumption or occupancy of computational resources, including processor usage, memory usage, and communication bandwidth, associated with an information processing element or an external function element.

The term “suitability index” refers to a composite numerical value calculated for each information processing element or external function element based on weighted contributions of at least a processing speed index, an accuracy index, and a resource utilization index, used for selecting an element for a given prompt sentence.

The term “weight coefficient” refers to a numerical factor applied to a metric or index when calculating the suitability index, thereby determining the relative importance of the metric or index in the selection process.

The term “processing request information” refers to structured data transmitted from the server to an information processing element or an external function element, including at least the prompt sentence and the requirement condition information.

The term “generative artificial intelligence model” refers to a machine-learned model configured to generate new data instances, such as text sequences, in response to an input, by estimating and sampling from a learned probability distribution.

The term “text generation processing” refers to a computation performed by a generative artificial intelligence model that produces one or more text sequences as output in response to an input prompt sentence.

The term “summarization processing” refers to a computation that transforms a longer input text into a shorter representation while preserving essential semantic content, performed at least in part by a generative artificial intelligence model.

The term “translation processing” refers to a computation that converts text from a source language into text in a target language, performed at least in part by a generative artificial intelligence model.

The term “question answering processing” refers to a computation that generates an answer text in response to a question expressed in a prompt sentence, based on learned or provided information.

The term “data analysis processing” refers to a computation that processes structured or unstructured data to extract patterns, summaries, interpretations, or other analytical outputs, optionally in combination with a generative artificial intelligence model to express the outputs in natural language.

The term “processing result” refers to an output produced by an information processing element or an external function element in response to processing request information, including at least a text output generated by a generative artificial intelligence model.

The term “output format conformity” refers to a degree to which a processing result satisfies structural and formatting requirements specified in the requirement condition information or otherwise predetermined.

The term “language type” refers to an identified natural language of a text output, such as a particular human language, determined by analysis of the processing result.

The term “structural requirements” refers to specified constraints on the internal organization of a processing result, including number of sections, presence of bullet points, key fields, or other structural elements.

The term “statistical technique” refers to a computational method based on probability theory or statistics, such as averaging, variance analysis, or probabilistic scoring, used to evaluate properties of processing results.

The term “machine learning technique” refers to a computational method that uses a trained model to perform prediction, classification, regression, or scoring based on input data, including but not limited to neural networks, decision trees, and ensemble methods.

The term “integrated result” refers to a single processing result generated by selecting one processing result from multiple candidates or by combining portions of multiple processing results according to predefined or learned rules.

The term “data structure” refers to an organized representation of data, such as a record, document, or message format, suitable for transmission, storage, or further processing.

The term “log storage element” refers to a memory structure configured to store history information, including prompt sentences, requirement condition information, selected elements, and integrated results, in association with execution events.

The term “history information” refers to recorded data describing past processing events, including at least a prompt sentence, requirement condition information, one or more selected elements, processing results, and performance metrics.

The term “task type discrimination model” refers to a model trained to classify a prompt sentence into one of a plurality of task types using natural language processing techniques.

The term “suitability index calculation model” refers to a machine-learned model configured to compute or assist in computing a suitability index for an information processing element or an external function element based on one or more input features.

The term “retraining” refers to a process of updating parameters of a machine-learned model by using additional training data, including history information, to improve the model's performance on a target task.

The term “selection logic” refers to a set of rules, algorithms, or model-based procedures that determine which information processing element or external function element is selected for processing a given prompt sentence.

The term “communication control processing” refers to operations executed by the server to manage sending and receiving of data over a communication network, including protocol handling, error handling, and connection management.

In one embodiment, the server operates on a computing platform that includes at least one central processing unit and, optionally, one or more graphics processing units connected via a system bus. The server executes an operating system such as a server-class operating system and runs middleware including a web server, an application framework, and a database management system. The server further uses a machine learning framework such as a tensor computation framework to execute a generative AI model and auxiliary machine learning models. The server stores configuration data, model metadata, performance metrics, and processing logs in one or more information storage elements such as a relational database and a log storage system.

The terminal operates as a client device, such as a personal computer, a tablet device, or a smartphone, that executes a web browser or a native application. The terminal provides a graphical user interface allowing the user to input a prompt sentence for a generative AI model, to transmit the prompt sentence to the server, and to receive and display generated results. The terminal does not perform heavy model inference but cooperates with the server through a communication network using a standardized protocol such as HTTP over a transport protocol.

The user interacts with the system by operating the terminal. The user inputs, for example, a prompt sentence such as “Summarize the following article in about 150 English words and highlight three key points at the end:” followed by article text. In another example, the user inputs a prompt sentence such as “Translate the following Japanese paragraph into English and then provide a one-sentence summary:” followed by the paragraph. In still another example, the user inputs a prompt sentence such as “Use the fastest available model to answer this question briefly: What are three advantages of using a generative AI model for document summarization?” or “You are an expert data analyst. From the following sales CSV data, detect any unusual spikes or drops in daily revenue and explain them in plain English. Then, summarize your findings in a bullet list:” followed by structured data. The server uses an information storage element to maintain a registry of heterogeneous information processing elements and external function elements. The server records, for each element, type information (for example, whether the element is a local text-generation engine, a translation engine, an analysis pipeline, or a remote API endpoint), processing capability information (for example, model size, supported task types, maximum throughput, typical output quality scores measured on benchmark datasets), usage state information (for example, current queue length, average response time over a recent window, active error flags), and operational performance information (for example, rolling averages of latency, error rate, and user rating scores). The server writes this information into one or more tables in the database and updates the information after each processing request. By structuring these data as indexed records with specific fields, the server enables efficient selection and re-ranking of resources, which directly improves resource utilization and reduces response time in comparison with static routing architectures.

The server executes a natural language processing module to analyze the prompt sentence. The server uses, for example, a tokenization algorithm and an embedding model to convert the prompt sentence into a sequence of tokens and then into a sequence of numerical vectors. The server may use a transformer-based encoder model with multiple self-attention layers, where each layer performs linear projections, scaled dot-product attention, and non-linear activation. The server uses the final-layer hidden vectors as features for downstream classifiers. The server applies at least one classifier model, such as a feed-forward neural network or a gradient-boosted decision tree model, to predict a task type label (e.g., summarization, translation, question answering, data analysis) and to infer other requirement condition information such as desired output format (e.g., bullet list, paragraph text, structured explanation), target language, and approximate desired output length. The server thus transforms the textual prompt sentence into structured requirement condition information that can be processed algorithmically.

The server generates a set of numerical indices used in a selection algorithm. The server reads processing capability information and operational performance information from the information storage element for each information processing element. The server calculates, for each element, a processing speed index by computing, for example, an inverse of a moving-average latency or a normalized value based on recent response time distribution. The server calculates an accuracy index by combining pre-measured benchmark scores and, optionally, user feedback scores. The server calculates a resource utilization index from current load indicators such as queue length and CPU/GPU utilization. The server then computes a suitability index as a weighted combination of these indices, where the server adjusts weight coefficients based on the requirement condition information. For instance, for a prompt sentence specifying “Use the fastest available model,” the server increases the weight of the processing speed index and decreases the weight of the accuracy index, whereas for a prompt sentence involving legal or safety-critical content, the server increases the weight of the accuracy index. This dynamic adjustment constitutes a non-human heuristic that uses objective machine-measured metrics and directly changes how computing resources are scheduled and assigned, thereby improving overall computational efficiency.

The server executes one or more generative AI models as information processing elements. In one embodiment, the server runs a transformer-based autoregressive language model. The server stores model parameters (weight matrices and bias vectors) in memory and executes batched matrix multiplications and attention calculations on a graphics processing unit using a parallel computation library. The server performs inference by repeatedly computing, for each decoding step, a probability distribution over the vocabulary and sampling or selecting the next token using a decoding strategy such as greedy decoding, beam search, or nucleus sampling. The server can also run encoder-decoder architectures for translation tasks, where an encoder maps an input sequence into a sequence of hidden representations and a decoder generates translated text conditioned on these representations. The server configures model hyperparameters such as the number of layers, the number of attention heads, and hidden dimension size according to available hardware capacity.

The server trains or fine-tunes auxiliary models for task type discrimination and suitability index calculation. The server initially trains these models using supervised datasets, where each training instance includes a prompt sentence and a ground-truth task type label or includes resource and performance features with a target selection label. The server defines a loss function, such as a cross-entropy loss for classification or a mean squared error loss for regression, and performs iterative optimization using a gradient descent method. The server updates model weights by computing gradients using backpropagation and applying an optimizer algorithm such as a variant of stochastic gradient descent. The server may apply data augmentation techniques, such as paraphrasing or template-based generation of prompt sentences, to increase training data diversity. During operation, the server performs retraining or incremental updating of these models by using history information stored in the log storage element. As a result, the selection logic evolves based on actual runtime behavior, enabling the computer system to learn patterns of prompt sentences, workload conditions, and model performance that are not intuitively accessible to a human operator.

The server applies specific validation and integration techniques to processing results. When the server obtains multiple candidate outputs from different information processing elements, the server performs structural validation by checking, for example, whether the output includes the required number of bullet points, whether the language of the output matches the specified target language, and whether mandatory sections or fields are present. The server may implement rule-based checks, such as regular expression matching or section labeling, combined with embedding-based similarity checks between the prompt sentence and the output. The server calculates reliability and accuracy indices for each candidate output by using statistical techniques or additional machine learning models, such as quality estimation models trained to predict human-judged quality from text features. The server then either selects the candidate output with the highest combined index or merges outputs by extracting consistent segments and recomputing coherence using a secondary generative model configured for editing and consolidation. This non-trivial integration process allows the server to reduce error rates and to increase robustness against outlier outputs from any single model instance.

The server uses a specific data flow to support these operations. The server receives prompt sentences and metadata from the terminal as structured messages. The server stores and retrieves registry information and logs in normalized tables, where each table includes primary keys and indexed fields to support efficient joins and queries. The server represents requirement condition information as typed records, for example including a task type field, a target language field, an output format field, and numeric constraint fields such as maximum tokens. The server represents suitability indices as numeric vectors in memory, indexed by element identifiers. By maintaining these data structures, the server reduces repeated computation, enables caching of intermediate selections, and supports consistent behavior across different modules. These specific data structures and flows produce technical effects such as reduced latency for model selection, more predictable memory usage, and easier scaling to additional information processing elements.

The terminal cooperates with the server in a way that further contributes to system-level technical improvements. The terminal can perform lightweight preprocessing such as local input validation and basic language detection to reduce invalid requests sent to the server. The terminal may also implement local result caching for repeated prompt sentences, thereby reducing network traffic and lowering average response time for certain interactions. The terminal sends structured usage feedback, such as explicit user evaluations or implicit interaction signals (for example, quick re-submission of a modified prompt sentence), which the server incorporates into operational performance information. This feedback loop allows the server to adjust selection behavior based on real user satisfaction, further enhancing effective accuracy and reliability.

The user benefits from the system's improved computer-implemented orchestration without needing to understand the underlying computation. The user only provides natural language instructions in the form of prompt sentences, whereas the server autonomously selects and coordinates appropriate generative AI models and hardware resources. For example, when the user provides a long technical article and the prompt sentence “Summarize the following article in about 150 English words and highlight three key points at the end:”, the server may select a high-capacity summarization model with strong accuracy metrics. When the user provides a short conversational query and the prompt sentence “Use the fastest available model to answer this question briefly: What are three advantages of using a generative AI model for document summarization?”, the server may instead select a smaller, faster model instance. This behavior is not a mere automation of human decision-making, but rather an algorithmic optimization that considers precise performance metrics and resource measurements, enabling the computer system to achieve overall throughput and quality that are not attainable by manual routing.

In various embodiments, the server can implement alternative or extended architectures while still applying the same selection and integration principles. The server can operate in a distributed environment where multiple physical machines host different generative AI models, and the server manages network communication between nodes. The server can integrate non-neural components, such as symbolic reasoning engines or specialized numerical solvers, as external function elements. The server can adapt to different generative AI model architectures, such as decoder-only transformers, encoder-decoder transformers, or retrieval-augmented generation models that access an external knowledge store. In each case, the server still uses the information storage element to record capabilities and performance, the natural language processing module to derive requirement condition information from the prompt sentence, and the suitability index computation to select the best-suited processing path. This modularity allows the system to scale and evolve as new models and hardware become available, while preserving the technical benefits of dynamic optimization. The system therefore provides more than an abstract arrangement of data retrieval and display. The server changes how computing resources are allocated and how generative AI models are invoked, based on quantitative measurements and machine-learned selection logic. This results in concrete technical effects: reduction in mean response time by assigning requests to underutilized or faster elements, improvement of output accuracy by matching task types to models with proven performance, reduction of hardware overloading and throttling by monitoring resource utilization and shifting load, and reduction of communication overhead by choosing local models whenever conditions permit. Because the server controls actual execution of matrix computations on processing units and manages data movement between storage and compute engines, the invention directly improves the functioning of the computer system itself, rather than merely providing an abstract organization of human tasks.

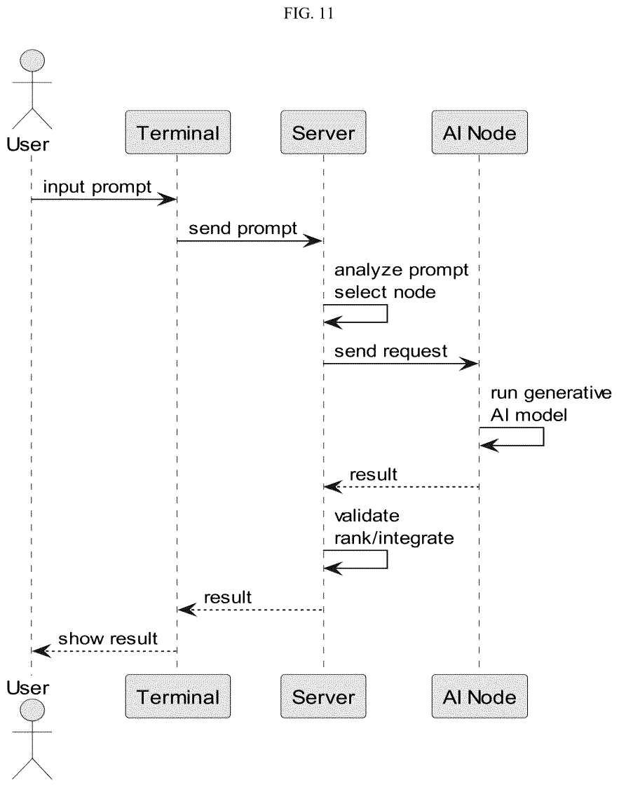

The following describes the processing flow using FIG. 11.

### Step 1:

The user inputs a prompt sentence into the terminal.

The user provides textual data, such as “Summarize the following article in about 150 English words and highlight three key points at the end:” followed by article text, or

“Translate the following Japanese paragraph into English and then provide a one-sentence summary:” followed by the paragraph. The user edits the text in an input field and triggers submission by pressing a send button or a key. The output of this step is a raw prompt sentence stored in the terminal's local memory.

### Step 2:

The terminal packages and transmits the prompt sentence to the server.

The terminal takes, as input, the raw prompt sentence and optional local metadata (such as a session identifier or user preference flags). The terminal performs data formatting by constructing a structured message (for example, a key-value representation in memory), attaches authentication or session tokens, and encodes the text using a character encoding scheme. The terminal then sends this encoded data as a request over a communication network using a transport protocol. The output of this step is a network message containing the prompt sentence as received by the server.

### Step 3:

The server receives and parses the incoming request.

The server takes the network message as input and performs protocol-level processing using a server-side communication stack. The server extracts headers and a message body, decodes the character encoding, and parses the structured message into internal variables representing the prompt sentence, identifiers, and configuration flags. The server performs basic validation, such as checking authentication and ensuring that the prompt sentence is non-empty. The output of this step is a validated prompt sentence and associated metadata stored in the server's working memory.

### Step 4:

The server performs text preprocessing on the prompt sentence.

The server takes the validated prompt sentence as input and executes preprocessing routines, including character code normalization, removal of control characters, unification of whitespace, and normalization of punctuation. The server may convert full-width characters to half-width characters and normalize line endings. These operations are implemented as string transformations and pattern-based replacements on the text data. The output of this step is a cleaned and normalized prompt sentence.

### Step 5:

The server performs natural language analysis to derive requirement condition information. The server takes the normalized prompt sentence as input and applies a natural language processing pipeline. The server tokenizes the sentence into tokens, converts the tokens into numerical embeddings using a language model, and feeds the embeddings into one or more classifier models. The server performs data computations such as matrix multiplications, non-linear activations, and softmax operations to predict labels for task type (for example, summarization, translation, question answering, data analysis), target output language, required output format (for example, bullet list or paragraph), and constraint conditions (for example, length constraints or speed preference). The output of this step is structured requirement condition information that includes task type, output format, target language, and constraint parameters.

### Step 6:

The server retrieves capability and performance records for available information processing elements.

The server takes, as input, the identifiers of registered information processing elements and external function elements, and the requirement condition information. The server issues database queries to an information storage element to read type information, processing capability information, usage state information, and operational performance information for each element. The server performs data retrieval and indexing operations to assemble, for each element, a record with fields such as average latency, benchmark accuracy, current load, and error rates. The output of this step is a collection of element records held in server memory.

### Step 7:

The server computes indices and a suitability score for each information processing element. The server takes the collection of element records and the requirement condition information as input. The server calculates a processing speed index from latency data (for example, by computing an inverse or normalized score), an accuracy index from benchmark and feedback scores, and a resource utilization index from current load metrics. The server applies arithmetic operations such as scaling, normalization, and weighted summation to these indices, using weight coefficients that may depend on the task type and constraint conditions. The server then computes, for each element, a suitability index that numerically represents how appropriate the element is for the current prompt sentence. The output of this step is a list of information processing elements paired with their computed suitability indices.

### Step 8:

The server selects one or more optimal information processing elements or external function elements.

The server takes the list of suitability indices as input and performs a ranking operation. The server sorts the elements by their suitability index and selects at least one top-ranked element as a primary execution target. The server may also select secondary elements for redundancy or comparison when higher reliability is required. The server can apply additional rules, such as excluding elements with recent critical errors or selecting local elements when network bandwidth is constrained. The output of this step is an ordered selection of one or more target elements designated to process the prompt sentence.

### Step 9:

The server constructs processing request information for the selected element.

The server takes the normalized prompt sentence, the requirement condition information, and the identity of the selected element as input. The server prepares a request structure containing fields such as the prompt content, task type flag, target language, output format, and numerical parameters including maximum token count and temperature. The server performs data serialization into the specific format required by the target element, for example, a request message schema defined for a local inference service or a remote API endpoint. The output of this step is a formatted processing request ready to be delivered to the selected information processing element or external function element.

### Step 10:

The server transmits the processing request to the selected element and initiates model inference.

The server takes the formatted processing request as input and uses a communication mechanism appropriate for the selected element. For a local element, the server may call an internal interface or send a request over an internal network. For a remote element, the server may use a network client to transmit the request. The selected element receives the request and passes the prompt sentence and parameters into a generative AI model. The server thereby triggers execution of computations such as tokenization, embedding lookup, attention-based transformations, and step-by-step token generation performed by the generative AI model. The output of this step, from the server's perspective, is a pending call awaiting one or more processing results.

### Step 11:

The server acquires processing results from the selected element.

The server takes, as input, responses returned by the information processing element or external function element. The server parses the response structure to extract generated text, model identifiers, token usage counts, processing time measurements, and any provided confidence scores. The server converts the response into a standard internal representation, such as a record containing the output text and associated metrics. The output of this step is one or more processing result records corresponding to the executed generative AI model or pipeline.

### Step 12:

The server validates structural and formatting properties of each processing result.

The server takes the processing result records and the requirement condition information as input. The server performs checks to verify that the output text satisfies structural requirements such as number of bullet points, presence of specified section headings, and compliance with a requested output format. The server may apply pattern-matching rules, character-level inspections, and language detection algorithms to ensure that the output uses the correct language type and general shape. The server flags any result that fails these checks. The output of this step is a set of labeled processing results indicating whether each result passes or fails the structural validation.

### Step 13:

The server computes reliability and accuracy indices for the candidate results.

The server takes the structurally validated results and associated metrics as input. The server applies statistical techniques or auxiliary machine learning models to estimate a reliability index and an accuracy index for each result. For example, the server may compute text similarity between the prompt sentence and the result, evaluate internal consistency using a secondary quality-estimation model, and combine these measures with performance metrics such as error history for the generating element. The server performs computations such as feature extraction from text, feature normalization, and scoring via learned models. The output of this step is a set of candidate results each associated with reliability and accuracy indices.

### Step 14:

The server selects or integrates processing results to form a single integrated result.

The server takes the scored candidate results as input and applies a selection or integration policy. If only one high-reliability result exists, the server may select it directly. If multiple results satisfy threshold conditions, the server may perform integration by comparing overlapping content, discarding inconsistent segments, and, optionally, using a generative refinement model to harmonize combined text. The server may also use ranking criteria that give priority to higher reliability and accuracy indices. The output of this step is a single integrated result text along with final quality indicators.

### Step 15:

The server logs history information for subsequent learning and optimization.

The server takes, as input, the prompt sentence, the requirement condition information, the selected elements, the integrated result, and measured performance metrics such as latency and token usage. The server constructs a history record with anonymized identifiers and stores it in a log storage element. The server may also update rolling averages and counters in the information storage element, thereby modifying operational performance information for the involved elements. The output of this step is an updated log and refreshed performance statistics that will influence future suitability index calculations.

### Step 16:

The server formats the integrated result and sends it to the terminal.

The server takes the integrated result text and related metadata as input. The server encapsulates the text and optional metadata (for example, model type, processing time) into a response structure, applies character encoding, and attaches appropriate response parameters. The server then transmits the response over the communication network to the terminal using the established protocol. The output of this step is a network response message containing the integrated result as received by the terminal.

### Step 17:

The terminal receives and displays the integrated result to the user.

The terminal takes the network response message as input and performs decoding and parsing to extract the integrated result text and optional metadata. The terminal updates its graphical user interface by rendering the text in a display region, possibly applying layout rules such as line wrapping and bullet formatting. The terminal may also store the prompt sentence and the result in a local history for later reference. The output of this step is a visual presentation of the integrated result on the terminal's display for the user.

### Step 18:

The user reviews the integrated result and optionally issues a follow-up prompt sentence.

The user takes the displayed result as input, evaluates whether it meets the original intent, and decides whether to accept, refine, or extend the request. If needed, the user edits or creates a new prompt sentence, such as “Make the summary shorter and focus on the financial aspects,” and submits it through the terminal. The output of this step is a new or modified prompt sentence that re-enters the processing flow starting from the earlier steps, enabling iterative improvement driven by the server's dynamic model selection and processing mechanisms.

### Application Example 1

Description follows regarding a flow of the specific processing in an Application

Example 1. The units of the system described below are implemented by the data processing device 12 and the smart device 14. The data processing device 12 is called a “server” and the smart device 14 is called a “terminal”.

Conventional management systems for industrial information processing units typically rely on static rule sets or manually configured routing logic to assign tasks to available computational resources. Such systems suffer from several technical limitations. First, they are unable to robustly interpret unstructured, natural-language task descriptions, and therefore require dedicated, application-specific interfaces and rigid parameter formats. Second, even when basic task routing is automated, conventional systems generally evaluate device capabilities on the basis of fixed configuration values, and do not continuously integrate real-time load conditions, historical reliability, or task-specific performance requirements in a unified manner. As a result, processing tasks may be assigned to non-optimal devices, leading to degraded throughput, increased latency, and reduced accuracy. Moreover, in distributed environments where multiple heterogeneous information processing units and external functions are available, conventional systems lack a scalable mechanism for calculating a suitability metric that dynamically combines device attributes, operational states, and task constraints extracted from user input. This prevents fine-grained optimization of resource selection for each individual task. In addition, typical systems return raw results or simple aggregated metrics to the user, without generating adaptive, context-aware explanations. They do not leverage generative artificial intelligence models to derive structured parameters from a natural-language prompt sentence, nor to produce human-readable explanations that reflect integrated results.

Furthermore, existing systems do not take into account the emotional state of the user when presenting results. They lack any technical mechanism to analyze voice data or text data from the user, infer an emotional state, and adjust the content or format of system responses accordingly. This can hinder effective human-computer interaction, particularly in environments where operators must quickly understand complex analytic outputs under stress or time pressure.

Accordingly, there is a need for an improved computer-implemented system that: (i) accepts natural-language prompt sentences from a user; (ii) uses a generative AI model and natural language processing techniques to transform such prompt sentences into structured parameters; (iii) calculates, on the basis of configuration information and real-time management information, a suitability index for a plurality of information processing units or external functions; (iv) automatically generates and dispatches control messages to selected resources; (v) integrates multiple processing results using statistical or machine learning techniques to compute reliability and accuracy indices; and (vi) generates and adaptively presents integrated results and explanatory texts in a manner adjusted to a detected emotional state of the user. By solving these problems, the invention aims to improve the functioning of the computer system itself, including task allocation efficiency, robustness of result integration, and usability of the human-machine interface.

The specific processing by the specific processing unit 290 of the data processing device 12 in Application Example 1 is realized by the following means.

The present invention provides a server comprising a processor and at least one storage unit, the processor being configured to record and update, in the storage unit, management information for a plurality of information processing units, the management information including type information, processing capability information, load state information, and usage history information of each of the plurality of information processing units; to receive a prompt sentence input by a user via a terminal, and analyze the prompt sentence by using a natural language processing technique and a generative AI model so as to convert the prompt sentence into structured parameters including at least a task type, a performance requirement, a time constraint, a target facility, and a target period; to calculate, on the basis of the structured parameters, the management information, and configuration information stored in the storage unit, a suitability index for each of the plurality of information processing units, and select, on the basis of the suitability index, one or more information processing units or external functions that satisfy at least the task type and the performance requirement; to generate, for each selected information processing unit or external function, a control message including an instruction content generated from the prompt sentence and the structured parameters by using the generative AI model, and transmit the control message via a communication interface so as to cause execution of a task corresponding to the prompt sentence; to collect processing results acquired from the information processing units or the external functions, calculate, by using at least one of a statistical technique and a machine learning technique, a reliability index and an accuracy index for the processing results, and integrate the processing results on the basis of the reliability index and the accuracy index to generate an integrated result on a task basis and summary information corresponding to the integrated result; and to output the integrated result and the summary information to the terminal via a user interface, analyze an emotional state of the user on the basis of voice data and text data acquired from the user, and adjust at least one of expression content and presentation format of the summary information in accordance with an analysis result of the emotional state. This enables improvement of the operation of the computer system by automatically transforming unstructured natural-language prompt sentences into optimized task assignments for heterogeneous information processing resources, dynamically selecting and commanding suitable resources based on real-time conditions and historical performance, robustly integrating multi-source results with quantified reliability and accuracy, and adaptively generating and presenting human-readable explanations tailored to the user's emotional state, thereby enhancing computational efficiency, result quality, and human-computer interaction.

The term “information processing unit” refers to a computing element, such as a hardware device or software execution environment, that is capable of executing data processing tasks, including but not limited to analysis, inference, control, or transformation of input data according to predefined algorithms or models.

The term “external function” refers to a processing capability or service that is provided outside of a local information processing unit, including but not limited to a remote computational service, an application programming interface, or a network-accessible software module that executes a specific task in response to a request.

The term “management information” refers to information maintained for each information processing unit, including at least type information, processing capability information, load state information, and usage history information, and used for monitoring, selecting, and controlling such units.

The term “type information” refers to information indicating a classification of an information processing unit, such as a functional category, supported task category, or hardware and software characteristics, that distinguishes the unit from other units.

The term “processing capability information” refers to information representing performance characteristics of an information processing unit, including but not limited to computational throughput, latency, supported model types, maximum data size, and resource capacity.

The term “load state information” refers to information indicating a current or recent utilization condition of an information processing unit, including but not limited to processor usage, memory usage, queue length, and concurrent task count.

The term “usage history information” refers to information indicating past operation records of an information processing unit, including but not limited to executed tasks, success and failure rates, accuracy records, and timestamps of past executions.

The term “prompt sentence” refers to a natural-language input string provided by a user that describes at least one desired task, requirement, or condition to be executed or satisfied by the system.

The term “natural language processing technique” refers to a computational technique for analyzing and processing human language text, including but not limited to tokenization, parsing, semantic analysis, entity extraction, and intent detection.

The term “generative AI model” refers to a machine-learned model configured to generate output data, such as text or structured data, in response to input data, and trained using at least one of deep learning and probabilistic modeling techniques.

The term “structured parameters” refers to a set of machine-interpretable values derived from a prompt sentence, including at least a task type, a performance requirement, a time constraint, a target facility, and a target period, and represented in a structured format such as key-value pairs or a data schema.

The term “task type” refers to a classification that identifies a category of processing to be performed, such as image analysis, anomaly detection, optimization, or control, and that is used for selecting suitable information processing units or external functions.

The term “performance requirement” refers to a constraint or target related to processing quality or efficiency, including but not limited to accuracy, response time, throughput, or resource consumption, that the system endeavors to satisfy when executing a task.

The term “time constraint” refers to a temporal condition, such as a deadline, maximum allowable latency, or processing time window, within which a task must be started, executed, or completed.

The term “target facility” refers to an entity or logical scope, such as an installation, line, zone, or group of equipment, that is associated with a task indicated by the prompt sentence.

The term “target period” refers to a time interval, such as a specific start time and end time, a duration, or a production period, over which data is to be acquired, processed, or analyzed for a task.

The term “configuration information” refers to information stored by the system that defines at least task classification information, evaluation criteria, and weighting coefficients, and that is used to control a calculation method of a suitability index and a selection criterion for information processing units or external functions.

The term “task classification information” refers to information that associates task types with one or more attributes, such as applicable device classes, default thresholds, or priority levels, for use in task routing and evaluation.

The term “evaluation criteria” refers to rules or conditions used to assess suitability, performance, or quality of information processing units or results, including but not limited to threshold values, comparison rules, and decision logic.

The term “weighting coefficient” refers to a numerical parameter used to weight one or more factors, such as performance metrics or reliability indices, when calculating a suitability index or an integrated result.

The term “suitability index” refers to a calculated value representing how appropriate a particular information processing unit or external function is for executing a task, in view of at least structured parameters, management information, and configuration information.

The term “control message” refers to a structured data message transmitted from the server to an information processing unit or an external function, the structured data message including at least instruction content and parameters that cause the receiving entity to perform a specified task.

The term “instruction content” refers to information contained in a control message that describes specific operations, processing conditions, or data to be handled by an information processing unit or an external function.

The term “communication interface” refers to a hardware and/or software component that enables transmission and reception of data between the server and external entities, including terminals, information processing units, and external functions.

The term “processing result” refers to output data generated by an information processing unit or an external function in response to a control message, including but not limited to analysis outcomes, predictions, classifications, or computed metrics.

The term “statistical technique” refers to a computational method based on statistics, such as averaging, variance estimation, hypothesis testing, or probabilistic modeling, used to evaluate or combine data.

The term “machine learning technique” refers to a computational method that uses data-driven models, including but not limited to regression models, classification models, or neural networks, to learn patterns from data and make decisions or predictions.

The term “reliability index” refers to a value indicating a level of trust or credibility associated with a processing result or an information processing unit, calculated based on at least past processing history, accuracy records, or error rates.

The term “accuracy index” refers to a value indicating a degree of correctness or precision of a processing result, calculated based on one or more performance measures such as detection accuracy, classification precision, or prediction error.

The term “integrated result” refers to a combined output generated by aggregating a plurality of processing results from information processing units or external functions, using at least one of the reliability index and the accuracy index.

The term “summary information” refers to information derived from an integrated result that provides a condensed or abstracted representation of key findings, including but not limited to aggregated metrics, overviews, and highlight explanations.

The term “terminal” refers to a user-side device, such as a workstation, portable device, or display apparatus, that communicates with the server to input prompt sentences and receive integrated results and summary information.

The term “user interface” refers to a hardware and/or software mechanism through which a user interacts with the system, including at least input components for prompt sentences and output components for integrated results and summary information.

The term “emotional state” refers to an inferred condition of a user's affect or attitude, such as stress, confidence, confusion, or urgency, determined based on analysis of voice data and text data associated with the user.

The term “voice data” refers to audio signals obtained from the user, including spoken utterances, that can be processed to extract features such as pitch, tone, and speech content.

The term “text data” refers to character-based data obtained from the user, including but not limited to typed input, chat messages, and annotations, that can be processed using natural language processing techniques.

The term “human-readable explanatory text” refers to text generated by the generative AI model that is intelligible to a human user and provides an explanation or description of at least an integrated result and associated structured parameters.

In one embodiment, the invention is implemented as a server that cooperates with at least one terminal and a plurality of information processing units deployed in an industrial environment. The server executes a computer program stored in a non-transitory storage unit. The program controls the server to manage device information, interpret a prompt sentence, select suitable information processing units or external functions, generate control messages, integrate processing results, and output an integrated result together with summary information.

The server comprises at least one processor, a main memory, a non-volatile storage unit, and a communication interface. The server uses a general-purpose computing platform, such as a multi-core processor architecture, a volatile memory, and a mass storage device. The server executes an operating system and application software implemented, for example, in a high-level programming language. The server stores a relational database in the storage unit. The server records, in tables of the database, management information for each information processing unit, including a device identifier, a device type classification, processing capability metrics, load state metrics, and usage history records. The server updates these records in real time or at predetermined intervals by receiving metrics from information processing units via the communication interface.

The server records, as processing capability metrics, values such as maximum throughput, average latency, model version identifiers, and supported task categories. The server records, as load state metrics, values such as CPU utilization, memory utilization, queue length, and an estimated remaining processing time for currently assigned tasks. The server records, as usage history, information such as task identifiers processed by the device, timestamps, success or failure flags, and observed accuracy metrics. The server stores this information in dedicated database tables that are indexed by device identifier and task type, thereby enabling efficient read and write operations.

The terminal comprises, for example, a display unit, an input unit, a network interface, and a processor. The terminal runs a client application, such as a web-based interface or a native application, configured to transmit a prompt sentence and related context to the server. The user operates the terminal to input a prompt sentence in natural language. The terminal transmits, to the server, the prompt sentence together with metadata such as user identifier, production line identifier, and priority level.

The server receives the prompt sentence and constructs an internal representation of the request. The server uses a natural language processing pipeline and a generative AI model to convert the prompt sentence into structured parameters. The server implements the natural language processing pipeline using a tokenization module, a part-of-speech tagging module, a dependency parsing module, and a semantic role labeling module. The server executes these modules on the processor, performing data operations such as token sequence generation, syntactic tree construction, and extraction of key phrases related to task type, performance requirement, time constraint, target facility, and target period.

The server uses the generative AI model to complement rule-based parsing and to map free-form natural-language expressions to a predefined parameter schema. In one embodiment, the generative AI model is implemented as a transformer-based neural network with an encoder-decoder architecture. The server stores, in the storage unit, model parameters such as weight matrices and bias vectors for multi-head self-attention layers, feed-forward layers, and layer normalization operations. The server loads these parameters into memory and executes the model on either a central processing unit or a graphics processing unit.

The server trains the generative AI model in advance by supervised learning. During training, the server uses training data that pairs natural-language prompt sentences with target structured parameter sets. The server computes a loss function, such as a cross-entropy loss over token sequences representing the structured output. The server updates the model parameters by using a gradient-based optimization algorithm such as stochastic gradient descent with momentum or an adaptive method. The server may employ data augmentation techniques, such as paraphrasing of prompt sentences or synthetic generation of constraint variations, to improve robustness. This training process results in a generative AI model that can reliably convert diverse prompt sentences into structured parameters with reduced ambiguity and improved generalization.

The server uses the structured parameters to calculate a suitability index for each registered information processing unit or external function. The server performs this calculation by combining management information and configuration information. The server stores configuration information in the storage unit as, for example, a table that associates task types with evaluation criteria and weighting coefficients for different metrics. The server retrieves, from the database, a vector of metrics for each candidate information processing unit, including normalized processing capability, current load, historical reliability, and historical accuracy for the relevant task type.

The server computes, for each device, a suitability index using a predetermined mathematical formula. In one embodiment, the server represents the suitability index as a weighted sum of normalized metrics. The server performs data normalization operations, such as min-max scaling or z-score normalization, to convert raw metrics into comparable ranges. The server then applies weighting coefficients that depend on the task type and performance requirement, for example placing higher weight on accuracy for inspection tasks and higher weight on latency for real-time control tasks. The server uses these computations to produce a numerical suitability index for each device.

The server selects one or more information processing units or external functions based on the suitability index and constraint satisfaction. The server eliminates devices that cannot meet a minimum required accuracy or a maximum allowed latency derived from the structured parameters. The server sorts remaining devices by suitability index and selects a subset, such as the top-ranked device or a combination of devices to achieve redundancy or parallel throughput. This selection process is not merely a static rule-based routing; it dynamically adapts to real-time operational data and task-specific requirements, thereby improving computational resource allocation compared to conventional static systems.

The server generates, for each selected information processing unit or external function, a control message that contains an instruction content and task parameters. The server uses the generative AI model to transform the original prompt sentence and the structured parameters into a detailed instruction text or structured directive. The server augments this with machine-readable fields such as input data source identifiers, processing mode flags, threshold values, and callback addresses. The server encapsulates these directives in a structured data format and transmits them through the communication interface.

The information processing unit receives the control message and executes a specific processing algorithm. In one embodiment, an information processing unit is configured to perform image analysis for defect detection. The unit obtains image data from cameras associated with a production line, preprocesses the image data by resizing, normalization, and noise reduction operations, and then applies a neural network model such as a convolutional neural network. The unit uses convolutional filters, pooling operations, and fully connected layers to compute feature maps and classification outputs. The unit outputs defect labels, bounding boxes, and confidence scores for each image.

The server receives processing results from the information processing units or external functions. The server stores these results in the database together with metadata such as device identifier, task identifier, timestamps, and internal metrics like processing time. The server computes, for each result set, a reliability index and an accuracy index by using statistical techniques and machine learning techniques. For example, the server may maintain a reliability model that estimates device-specific reliability based on past success rates and error patterns. The server may also train a regression or classification model to predict expected accuracy under given load conditions and task types.

The server integrates multiple processing results by weighting contributions from each device according to the reliability index and accuracy index. The server executes aggregation operations such as weighted averaging of probability distributions, majority voting with reliability-based tie-breaking, and conflict resolution based on historical performance profiles. These operations are performed by numerical computations on the processor, using vector and matrix operations to efficiently combine large numbers of predictions. This integration method reduces the impact of outlier devices and yields a more robust integrated result than simply aggregating raw outputs.

The server generates summary information from the integrated result. The server derives summary metrics such as total count of processed items, number of detected anomalies, distribution of defect types, and statistical confidence intervals. The server then uses the generative AI model in a different configuration to produce a human-readable explanatory text. For this purpose, the server encodes the integrated result and summary metrics into a structured input representation, such as a sequence of key-value tokens, and conditions the generative AI model to output an explanation that references these values. The server instructs the generative AI model to adhere to a concise and technically accurate style so that the user can quickly comprehend the output.

The server also analyzes an emotional state of the user based on voice data and text data captured at the terminal. The terminal records, for example, audio of spoken commands or comments and transmits them to the server together with user text input. The server applies a feature extraction algorithm to the voice data, computing features such as pitch contour, energy, and spectral characteristics. The server applies a text sentiment analysis model to the text data, using embeddings and classification layers to infer sentiment categories. The server combines the voice-based features and text-based features in a classifier model, such as a neural network, to estimate an emotional state label or a continuous emotional score.

The server adjusts, based on the estimated emotional state, at least one of the expression content and the presentation format of the summary information. For example, when the user is inferred to be under high stress, the server may instruct the terminal to present a simplified explanation with highlighted key actions and fewer technical details. When the user is inferred to be in a normal state, the server may present more detailed statistical context and auxiliary graphs. This emotional-state-dependent adaptation improves the usability of the interface and reduces the cognitive load on the user without altering the underlying computational results.

The terminal receives the integrated result and summary information from the server. The terminal renders, on its display unit, graphical and textual representations of the results. The terminal may visualize defect locations on images, show trend graphs of defect counts, and display the explanatory text generated by the generative AI model. The user reads these outputs and may issue new prompt sentences or take actions in the controlled environment. In a concrete example, the user operates the terminal and enters the following prompt sentence:
“In the inspection process for product A, select the image recognition AI with the highest detection accuracy and perform defect detection on all items produced in the last 30 minutes.”

The terminal transmits this prompt sentence to the server. The server converts the expression “inspection process for product A” into a specific task type associated with image analysis for a particular product category. The server interprets “highest detection accuracy” as a performance requirement with a high accuracy weight and a minimum acceptable threshold. The server interprets “last 30 minutes” as a target period and computes the corresponding time window. The server then calculates suitability indices, selects appropriate information processing units, dispatches control messages, integrates the returned results, and generates a summary tailored to the user's emotional state.

In another example, the user enters:
“For line 3, choose the information processing device that can complete visual inspection within 2 seconds per item, and detect scratches and dents on the surface.”

The server interprets “within 2 seconds per item” as a strict time constraint and adjusts weighting coefficients to prioritize latency. The server interprets “scratches and dents” as target defect classes and ensures that only devices with models trained for these defect types are considered. The server then selects devices with adequate throughput and relevant model capabilities. This dynamic adjustment of selection criteria according to task-specific constraints is performed by computations in the server and leads to improved adherence to real-time requirements and improved defect coverage.

The described system provides technical effects that go beyond mere automation of human judgment. The server improves data management by maintaining normalized and indexed management information and by continuously updating device metrics in the database, which allows efficient querying and selection operations. The server improves processing speed and computational efficiency by using vectorized operations and pre-computed normalization parameters to calculate suitability indices. The server reduces communication load by selecting only a subset of devices to receive control messages, based on suitability indices and constraints, and by aggregating multiple results before transmitting summary information to the terminal.

The server also improves accuracy and robustness of analytical outputs by integrating multi-source results using explicit reliability and accuracy indices rather than unweighted aggregation. This integration reduces error rates and provides more consistent outputs across varying load conditions and device states. The use of structured parameters derived from the prompt sentence enables the server to control devices with fine-grained specifications that would be difficult for a human operator to manage manually, particularly when many devices and constraints are involved. The generative AI model is not used as a black box; it is constrained by the parameter schema and configuration information, and its outputs are post-processed and validated by deterministic logic, resulting in predictable and technically meaningful behavior.

The system can be implemented in multiple variations. In one variation, the generative AI model is executed locally on the same server. In another variation, the generative AI model is executed on a separate accelerator node, and the server communicates with the node over a network. In still another variation, a simplified rule-based natural language parser is combined with a smaller generative model to reduce computational load. The suitability index calculation may employ different formulae, such as non-linear scoring functions or optimization-based selection, depending on deployment requirements. The reliability and accuracy indices may be computed using different statistical models, such as Bayesian estimators or ensemble learning methods.

In all these embodiments, the server, the terminal, and the information processing units cooperate in a specific data flow and algorithmic structure that improves computer-centric technical performance, including dynamic resource allocation, reliable result integration, and adaptive user interaction. The described system thus provides a concrete technical implementation that allows one skilled in the art to realize the claimed invention.

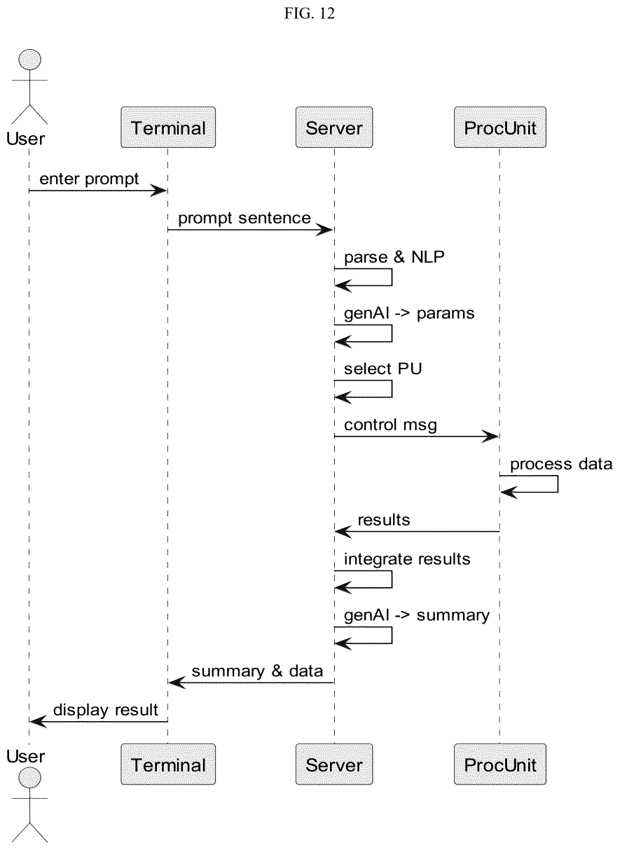

The following describes the processing flow using FIG. 12.

### Step 1:

The user operates the terminal to input a prompt sentence in natural language and confirms transmission. The input of this step is the user's textual prompt sentence and optional context data such as a line identifier or priority. The terminal packages the prompt sentence and context into a structured request, adds metadata including user identifier and timestamp, and outputs a network request that is transmitted to the server via a communication interface.

### Step 2:

The server receives the network request from the terminal and parses the contained data. The input of this step is the structured request including the prompt sentence, metadata, and context fields. The server validates the request format, checks required fields, and performs basic authentication and authorization based on the user identifier. The server outputs a validated internal request object stored in memory, which serves as the basis for subsequent natural language processing.

### Step 3:

The server performs natural language preprocessing on the prompt sentence. The input of this step is the raw text of the prompt sentence and the internal request object. The server executes tokenization, part-of-speech tagging, and syntactic parsing to generate tokens, tags, and dependency structures. The server computes word embeddings or token embeddings as numerical vectors and identifies candidate phrases corresponding to task type, performance requirement, time constraint, target facility, and target period. The output of this step is a preprocessed linguistic representation that includes tokens, syntactic structures, and preliminary extracted phrases.

### Step 4:

The server uses the generative AI model to convert the preprocessed linguistic representation into structured parameters. The input of this step is the tokenized and parsed prompt sentence, along with configuration data that describes a parameter schema. The server feeds the token sequence and positional encodings into the transformer-based generative AI model, which performs self-attention and feed-forward computations to generate a sequence of output tokens representing key-value pairs. The server decodes these tokens into machine-readable structured parameters such as task type, required accuracy, maximum latency, target facility identifier, and time window. The output of this step is a structured parameter set stored in a data structure, for example an in-memory dictionary.

### Step 5:

The server refines and normalizes the structured parameters using deterministic rules and configuration information. The input of this step is the structured parameter set and configuration tables stored in the database. The server converts qualitative expressions such as “highest detection accuracy” into numerical thresholds and weights, converts temporal expressions such as “last 30 minutes” into concrete start and end timestamps, and maps generic task descriptions to internal task codes. The server performs data type conversions and consistency checks, and outputs a normalized parameter set that is aligned with internal task classification and evaluation criteria.

### Step 6:

The server retrieves management information for candidate information processing units and external functions. The input of this step is the normalized parameter set, including task type and required capabilities, and database tables that store device type information, processing capability metrics, load state metrics, and usage history. The server issues database queries filtered by task type and supported function, and receives result sets containing records for relevant devices. The server outputs a device information matrix that consolidates type, capability, load, and historical performance for each candidate device.

### Step 7:

The server calculates a suitability index for each candidate information processing unit. The input of this step is the device information matrix, the normalized parameter set, and configuration information specifying evaluation criteria and weighting coefficients. The server normalizes numerical metrics such as throughput and latency using normalization functions, multiplies each normalized metric by a task-specific weighting coefficient, and sums the weighted metrics to obtain a suitability score. The server may also incorporate historical reliability and accuracy by adding or scaling corresponding terms in the score. The output of this step is a list of device identifiers and associated suitability indices.

### Step 8:

The server selects one or more optimal information processing units or external functions based on the suitability indices and constraints. The input of this step is the list of device identifiers with suitability indices and constraint values such as minimum accuracy or maximum latency. The server filters out devices that do not satisfy the constraints, sorts the remaining devices by suitability index, and applies selection logic to choose a subset, for example the top-ranked device or a combination of primary and backup devices. The output of this step is a selected device set with identifiers and selection rationale stored in memory and optionally recorded in the database.

### Step 9:

The server generates control messages for the selected information processing units or external functions. The input of this step is the selected device set and the normalized parameter set derived from the prompt sentence. The server uses the generative AI model to transform the structured parameters and parts of the original prompt sentence into detailed instruction content, and augments this content with concrete machine-readable fields such as data source identifiers, processing thresholds, batch sizes, and callback endpoints. The server organizes these elements into a structured control message format for each selected device. The output of this step is a set of control messages ready for transmission.

### Step 10:

The server transmits the control messages to the selected information processing units or external functions via the communication interface. The input of this step is the set of control messages and the network addressing information for each device. The server establishes connections, sends the control messages using a predetermined protocol, and waits for acknowledgments. The server records acknowledgment status and estimated completion times in the database. The output of this step is a set of confirmed task assignments associated with device identifiers and task identifiers.

### Step 11:

The information processing unit receives a control message and prepares local data for processing. The input of this step is the control message containing instruction content and data source identifiers. The information processing unit parses the message, extracts parameters such as target time window and processing mode, and connects to local or remote data sources such as image streams or sensor logs. The information processing unit reads the relevant data, applies preprocessing operations such as resizing, normalization, filtering, or windowing, and outputs preprocessed data batches ready for model execution.

### Step 12:

The information processing unit executes a task-specific computational model or algorithm on the preprocessed data. The input of this step is the preprocessed data and model parameters stored locally, such as weights of a convolutional neural network or coefficients of a statistical model. The information processing unit performs forward computations, including convolution, activation, pooling, dense layer multiplication, or anomaly score calculation, depending on the task type. The information processing unit generates per-item outputs such as class labels, bounding boxes, anomaly scores, or numerical metrics. The output of this step is a processing result set containing predictions and associated confidence values.

### Step 13:

The information processing unit formats and transmits its processing result set to the server. The input of this step is the raw output of the computational model and metadata such as processing time and resource utilization. The information processing unit encapsulates the results into a structured format including item identifiers, predicted labels, confidence scores, timestamps, and any diagnostic information requested in the control message. The information processing unit sends this structured result to the server using a predetermined protocol. The output of this step is a result message delivered to the server's communication interface.

### Step 14:

The server receives and stores processing results from the information processing units or external functions. The input of this step is a set of result messages containing predictions and metadata for each assigned device. The server validates the schema, associates each result with the corresponding task identifier, and writes the data into result tables in the database. The server may perform preliminary aggregation, such as counting processed items or computing average processing time per device. The output of this step is a stored multi-source result set accessible for integration.

### Step 15:

The server calculates reliability indices and accuracy indices for the processing results. The input of this step is the multi-source result set, usage history records, and statistical or machine learning models used for reliability estimation. The server computes reliability indices by combining historical success rates, observed error patterns, and recent consistency of each device's outputs. The server may apply a prediction model that takes as input device identity, task type, and current load metrics to estimate an expected accuracy. The server outputs a set of reliability indices and accuracy indices attached to each device's result subset.

### Step 16:

The server integrates the multiple processing result subsets into a single integrated result. The input of this step is the result subsets, each annotated with reliability and accuracy indices. The server applies numerical aggregation algorithms such as weighted averaging of probabilities, reliability-weighted majority voting for discrete decisions, or conflict resolution rules that prefer results from devices with higher indices. The server performs vector and matrix operations to combine predictions across devices item by item. The output of this step is an integrated result that contains consolidated predictions, overall confidence measures, and derived metrics such as defect counts or anomaly rates.

### Step 17:

The server generates summary information and a human-readable explanatory text based on the integrated result. The input of this step is the integrated result and derived metrics such as counts, distributions, and time-based statistics. The server computes summary statistics, including total items processed, number and types of detected issues, and aggregate confidence levels. The server converts these statistics into a structured representation and provides it as context to the generative AI model. The generative AI model transforms this structured representation into an explanatory text, which the server post-processes to ensure consistency with numerical values. The output of this step is a pair consisting of structured summary information and an explanatory text.

### Step 18:

The server analyzes an emotional state of the user and adapts the presentation of the summary information. The input of this step is voice data and text data associated with the user, along with the structured summary information and explanatory text. The server extracts acoustic features from the voice data and linguistic features from the text data, feeds them into an emotional state classifier, and obtains an emotional state label or score. The server selects a presentation profile based on this emotional state, and modifies the explanatory text or highlights in the structured summary, for example by simplifying phrasing or emphasizing alerts. The output of this step is adapted summary content that matches the user's inferred emotional state.

### Step 19:

The server sends the integrated result and adapted summary content to the terminal. The input of this step is the integrated result, the adapted explanatory text, and any additional visualization data such as coordinates for defects or trend values. The server packages these outputs into a response message addressed to the terminal and transmits the message via the communication interface. The output of this step is a response received by the terminal, containing all data necessary for display.

### Step 20:

The terminal renders the integrated result and adapted summary content for the user. The input of this step is the response message from the server, including structured result data and explanatory text. The terminal parses the data, generates visual elements such as tables, charts, and annotated images, and displays them on the screen together with the explanatory text. The terminal may also generate audio output if required. The output of this step is a user interface view that presents the final results and explanations, enabling the user to understand the outcome and optionally input a new prompt sentence for a subsequent cycle.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In modern distributed computing environments, users increasingly issue diverse and complex prompt sentences, including natural language instructions and associated data such as documents and images, to request advanced information processing such as text summarization, translation, style conversion, and object recognition. Conventional systems typically rely on static routing rules or manually configured workflows to direct such requests to individual processing engines or external services. As a result, these systems suffer from several technical problems at the level of computer operation itself.

First, conventional systems are not configured to perform fine-grained, context-aware analysis of prompt sentences in order to automatically determine an appropriate task type and associated processing conditions. Routing decisions are often based on coarse metadata (for example, data type flags or endpoint identifiers) without leveraging generative AI models for deep semantic classification. This leads to suboptimal selection of processing engines, increased latency due to unnecessary calls or reprocessing, and degraded use of computational resources such as processors and network bandwidth.

Second, conventional systems generally lack an integrated mechanism for centrally managing heterogeneous electronic devices and external functions while simultaneously considering device attributes, processing capability, and operation state when selecting a processing target. Without a unified database and selection logic, the host computer cannot efficiently balance load, avoid overloaded or idle devices, or automatically adapt to configuration changes. This results in inefficient utilization of hardware resources, increased response time, and reduced scalability of the overall computer system.

Third, conventional systems frequently handle each processing engine in isolation and do not automatically construct multi-stage processing flows in which an output from one engine is supplied as an input to another engine in a coordinated manner. In such systems, orchestration of multi-step processing, such as combining optical character recognition, text summarization, and style adjustment, often requires manual programming or explicit user operation. This impairs the computer's ability to flexibly chain services, increases development complexity, and prevents dynamic optimization of end-to-end processing pipelines.

Fourth, conventional systems do not sufficiently integrate user emotion analysis into the core processing pipeline at the system level. Although some interfaces may perform sentiment analysis, they rarely adjust the internal routing, response length, style, or level of detail in a systematic, programmatic manner. As a consequence, the same underlying computer resources may produce responses that are poorly aligned with the user's emotional state, thereby causing unnecessary back-and-forth interactions, redundant computations, and inefficient consumption of processing and communication resources.

Therefore, there is a need for an improved computer-implemented system and method that (i) centrally manages multiple electronic devices and external functions in a unified architecture, (ii) utilizes natural language processing programs and generative AI models to semantically analyze prompt sentences and automatically derive task types and processing conditions, (iii) selects and orchestrates optimal processing targets, including multi-stage flows, based on both task context and device state, and (iv) analyzes user emotion from voice and text to dynamically adapt response generation. Such a system should improve the efficiency, scalability, and responsiveness of computer resources and provide a technically improved way of handling complex, multi-modal prompt-driven processing.

The specific processing by the specific processing unit 290 of the data processing device 12 in Example 2 is realized by the following means.

The present invention provides a server comprising a processor configured to record and refer to attribute information, processing capability information, and operation state information of a plurality of electronic devices in an information storage device so as to centrally manage the plurality of electronic devices; to acquire natural language data or image data including a prompt sentence input from a terminal, to analyze context information of the prompt sentence and data type information by using a natural language processing program and an image processing program, and to structure an analysis result as task type information and processing condition information; to select, on the basis of the task type information, the processing condition information, and the attribute information, processing capability information, and operation state information of the plurality of electronic devices, at least one processing target from among the plurality of electronic devices and external functions; to generate an internal prompt sentence to be input to a generative artificial intelligence model for the selected processing target, to transmit a request including the internal prompt sentence to the selected processing target, and to cause execution of information processing including at least one of text summarization, translation, style conversion, and object recognition; to receive processing result data from the selected processing target, to normalize and format-convert the processing result data, or to integrate a plurality of pieces of processing result data, and to generate response data that is transmittable to the terminal; to analyze voice data and text data input from a user to extract emotion state information, and to adjust content, expression style, and level of detail of the response data in accordance with the emotion state information and the task type information; and to transmit the response data to the terminal and repeatedly perform a process of accepting input of a new prompt sentence that enables continuation of interaction with the user. This enables the computer system to perform context-aware classification and routing of prompt sentences using generative AI, to dynamically select and orchestrate heterogeneous processing resources based on real-time device state and task requirements, to construct and execute multi-stage processing flows without manual intervention, and to adapt response generation to user emotion, thereby improving the efficiency, throughput, and responsiveness of the underlying computing infrastructure.

The term “electronic device” refers to a hardware apparatus including at least one processor and a memory, capable of executing a program to perform data input, data processing, and data output, and including, for example, a computer, a server, a storage apparatus, or a network node.

The term “information storage device” refers to a hardware and software combination configured to store and retrieve data, including, for example, a memory device, a magnetic storage device, a solid-state storage device, or a database system.

The term “attribute information” refers to information indicating inherent characteristics of an electronic device, including at least one of a device type, a supported function, a supported data format, a hardware configuration, or a software configuration.

The term “processing capability information” refers to information representing a quantitative or qualitative capability of an electronic device to perform data processing, including at least one of a processing speed, a memory capacity, a storage capacity, a network bandwidth, or a supported algorithm.

The term “operation state information” refers to information indicating a current or recent operational condition of an electronic device, including at least one of a load state, a utilization rate, an error state, an availability state, or a response time.

The term “terminal” refers to an electronic device used by a user to input data and receive data from a server over a communication network, including, for example, a client computer, a mobile communication device, or a display apparatus.

The term “prompt sentence” refers to a natural language expression or an equivalent textual instruction provided by a user to specify a desired processing task, including, for example, a request for summarization, a request for translation, a request for style adjustment, or a request for image analysis.

The term “natural language data” refers to data represented by words, phrases, or sentences in a human language, including, for example, text strings, documents, messages, or transcribed speech.

The term “image data” refers to data representing a two-dimensional or multi-dimensional visual pattern, including, for example, a photograph, a scanned image, a graphical object, or a frame of a moving image.

The term “natural language processing program” refers to software configured to analyze or generate natural language data, including functions such as tokenization, part-of-speech tagging, syntactic analysis, semantic analysis, classification, or generation.

The term “image processing program” refers to software configured to analyze or transform image data, including functions such as feature extraction, object detection, classification, segmentation, or transformation.

The term “context information” refers to information obtained from or related to a prompt sentence that is usable for understanding the meaning or intent of the prompt, including at least one of a task purpose, a subject matter, a requested output property, or a related constraint.

The term “data type information” refers to information indicating a kind or format of input data, including at least one of text data, image data, audio data, structured data, or a combination thereof.

The term “task type information” refers to information representing a categorized type of processing requested by a prompt sentence, including at least one of text summarization, translation, style conversion, sentiment analysis, or object recognition.

The term “processing condition information” refers to information representing detailed conditions for performing a task, including at least one of an output length, an output language, a style requirement, a format requirement, or a priority.

The term “processing target” refers to at least one selected entity that performs data processing in response to a prompt sentence, including at least one of an electronic device, a software component, or an external function accessible over a communication network.

The term “external function” refers to a processing capability provided by a system or service separated from a server that performs routing, and accessible through an interface such as an application programming interface.

The term “generative artificial intelligence model” refers to a machine learning model configured to generate data such as text, images, or other content based on learned patterns from training data, and including, for example, a probabilistic language model, a neural network model, or a transformer model.

The term “internal prompt sentence” refers to a prompt sentence generated within a server and provided to a generative artificial intelligence model or other processing target, the internal prompt sentence being derived from a user's prompt sentence and including additional constraints or instructions.

The term “information processing” refers to a series of operations executed by a processing target on input data to produce output data, including at least one of text summarization, translation, style conversion, sentiment analysis, object recognition, or data transformation.

The term “processing result data” refers to data output from a processing target after execution of information processing, including at least one of generated text, classification labels, recognition results, or transformed data.

The term “response data” refers to data generated for transmission to a terminal as a response to a prompt sentence, the response data being based on processing result data and optionally including a text output, structured information, or a combination thereof.

The term “voice data” refers to audio data representing spoken utterances of a user, including, for example, live speech captured by a microphone or pre-recorded audio signals.

The term “text data” refers to data represented by characters, symbols, or strings in a machine-readable text format, including, for example, user input sentences, chat logs, or document content.

The term “emotion state information” refers to information representing an estimated emotional condition of a user, including at least one of positive, negative, neutral, or specific emotions such as happiness, sadness, anger, or anxiety.

The term “expression style” refers to a manner of presenting text in a response, including at least one of formality level, politeness level, tone, structure, or narrative style.

The term “processing flow information” refers to information defining an order, dependency, or interconnection among plural processing targets, including at least one of execution sequence, data routing rules, and input-output format mappings.

The term “multi-stage processing” refers to a processing method in which an output of a first processing target is provided as input to a second processing target, and optionally further propagated to additional processing targets, to form a processing chain.

In one embodiment, a server cooperates with at least one terminal operated by a user and with a plurality of electronic devices connected via a communication network. The server includes at least one processor, a main memory, a non-volatile storage device, and a communication interface. The processor executes a program stored in the non-volatile storage device and loaded into the main memory to perform centralized management of the plurality of electronic devices, semantic analysis of a prompt sentence, selection and orchestration of processing targets, invocation of a generative AI model, and generation of response data for the terminal.

The server stores, in an information storage device such as a relational database system or a key-value store, a device registry that maintains attribute information, processing capability information, and operation state information for each electronic device. The device registry uses specific data structures, for example a table or record structure that includes fields for device identifier, device type, supported task types, maximum throughput, average latency, memory capacity, and current utilization metrics. The server updates the operation state information by periodically collecting monitoring data from the electronic devices, for example through an agent program running on each electronic device or through a network monitoring protocol. By maintaining these data structures and continuously refreshing their contents, the server improves load distribution and reduces response time compared with a static configuration.

The terminal operates as a client computing device, such as a workstation, a mobile communication device, or an embedded control panel. The terminal executes an application that displays a graphical user interface enabling the user to input a prompt sentence and to provide associated data such as a document or an image. The user types or selects a prompt sentence, for example:
“Please summarize the following report in about 150 English words.” or “Please recognize the objects in this image and describe them in simple English.” or “Please translate the following Japanese email into polite English and make the tone slightly more formal.” The terminal converts the user input into request data including at least the prompt sentence, an optional content body such as text or image data, and metadata such as user identifier and timestamp. The terminal sends this request data to the server over a network using a communication protocol such as HTTPS. The terminal later receives response data from the server and presents the resulting information in a structured format, for example showing a summarized text or overlaying labels on an image.

The server executes a natural language processing program and, when appropriate, an image processing program to analyze the prompt sentence and associated data. In one embodiment, the server uses a natural language processing library that performs tokenization, part-of-speech tagging, dependency parsing, and named entity recognition on the prompt sentence.

The server constructs feature vectors representing the prompt sentence, where each vector can include token IDs, part-of-speech tags, n-gram frequencies, and embeddings obtained from a language model. For image data, the server optionally uses an image analysis module that inspects image metadata, file format, and size to determine suitability for image recognition tasks.

The server then uses a generative AI model as a classifier for task type determination and as a generator for final outputs. The generative AI model adopts a neural network architecture, for example a transformer architecture with multiple self-attention layers, feed-forward layers, and normalization layers. Each transformer layer maintains parameter matrices for query, key, value, and output projections, and the server stores these parameters as weight tensors accessible to the processor. During inference, the server inputs tokenized representations of the internal prompt sentence into the transformer, and the processor performs matrix multiplications, attention weight computations, non-linear activations, and softmax operations in a sequence that is optimized for the underlying hardware, such as a graphics processing unit or a tensor processing unit.

The server generates an internal prompt sentence from the user's prompt sentence for classification. For example, the server generates a prompt such as:
“Classify the user's request into one task type. User prompt: ‘Please summarize the following report in about 150 English words.’ Output exactly one label: [summarization, translation, style_conversion, sentiment_analysis, image_recognition, other].”

The server provides this internal prompt sentence as input to the generative AI model and obtains a textual label, such as “summarization,” as output. The server parses the label and stores it as task type information. In this way, the server uses the generative AI model not merely as a conversational engine but as a programmable classification component driven by explicit internal prompt sentences. This approach allows the server to handle complex and evolving language patterns more flexibly than fixed rule-based systems, thereby improving classification accuracy and reducing misrouting of requests.

The server further derives processing condition information from the generative AI model by issuing additional internal prompt sentences that specify, for example, desired output length, target language, style constraints, and formatting requirements. By encoding these constraints into structured data fields, the server can subsequently generate consistent, machine-readable instructions for downstream processing targets. The server thereby converts unstructured user input into a precise internal representation that allows deterministic routing and scheduling of computational tasks.

The server selects one or more processing targets among the plurality of electronic devices and external functions based on the task type information, the processing condition information, and the device registry. In one embodiment, the server applies a selection algorithm that combines rule-based conditions and learned scoring. The server calculates a score for each candidate processing target by using a function of at least the following elements: task-device compatibility, estimated processing latency derived from historical latency and current utilization, and estimated quality score, which can be precomputed for each device-task pair. The processor stores these scores in a ranking structure such as a priority queue or an ordered list. The server selects, as the processing target, the device with the highest score satisfying resource constraints and access policies. By performing this selection dynamically using real-time operation state information, the server improves throughput and reduces congestion on specific devices, which leads to technical benefits such as lower average response time and more stable performance in large-scale deployments. The server generates an internal prompt sentence for the generative AI model used as the final processing engine. For example, in a text summarization case, the server constructs an internal prompt sentence:
“You are an expert summarization assistant. Summarize the following report in about 150 English words, preserving key technical details and discarding redundant explanations: [report text].”

In a translation and style conversion case, the server constructs an internal prompt sentence:
“You are a professional translator. Translate the following Japanese email into polite English and make the tone slightly more formal, suitable for a business context: [Japanese email text].”

The server passes these internal prompt sentences, together with any necessary context data, to the generative AI model. The processor then causes the generative AI model to generate a token sequence representing the output text. The generative AI model computes at each decoding step a probability distribution over vocabulary tokens using the transformer architecture. The server applies decoding strategies such as greedy selection or top-k sampling with temperature scaling to reduce repetition and maintain coherence. By controlling generation parameters explicitly in response to processing condition information, the server balances quality and speed, thereby improving computational efficiency. The server receives processing result data from the selected processing target, which may be the generative AI model itself or another specialized device such as an image recognition engine. The server normalizes the processing result data using a post-processing module that performs operations such as trimming leading acknowledgement phrases, converting enumeration formats, and mapping classification results to multi-lingual label sets. The server uses structured data models, for example including fields for result text, confidence scores, detected entities, and error flags, to ensure consistent downstream handling. By operating on well-defined data structures instead of raw text, the server can combine outputs from multiple stages with reduced parsing overhead and lower error probability.

The server optionally constructs multi-stage processing flows when the selected processing targets include multiple electronic devices or external functions. For example, the server may first send image data to an optical character recognition engine, then pass the resulting text to the generative AI model for summarization, and then pass the summarized text to a style conversion engine. The server encodes such flows as processing flow information, which indicates execution order, data dependencies, and input-output format mappings. The processor interpretively traverses this processing flow information and automatically propagates intermediate results from one device to the next without user intervention. This orchestration reduces manual configuration and decreases the number of network round-trips by batching intermediate data where appropriate, thereby providing a technical effect of reduced latency and reduced communication load across the network.

The server analyzes voice data and text data provided by the user to extract emotion state information. The server may use a neural network classifier that takes as input spectral features of voice data (for example Mel-frequency cepstral coefficients) and embedding vectors of text segments. The classifier uses a supervised learning approach with a cross-entropy loss function to estimate probabilities for multiple emotion classes. The model architecture can include recurrent neural network layers, convolutional layers, or transformer layers. During training, the server updates the weight parameters by gradient descent using backpropagation, and may apply data augmentation techniques such as pitch shifting or noise injection for voice and synonym replacement or back-translation for text. By deploying this trained model in the server, the system can estimate emotion states in a manner that is more robust and fine-grained than simple keyword-based sentiment analysis.

The server uses the emotion state information together with the task type information and processing condition information to adjust the response data. For example, when the emotion state indicates confusion or frustration, the server increases the target explanation level by modifying internal prompt sentences to require more detailed, step-by-step outputs and less technical jargon. When the emotion state indicates that the user is in a neutral or expert mode, the server reduces verbosity to save processing time and bandwidth. This adaptive behavior changes the amount of data generated and transmitted, thereby improving both user experience and system performance through reduced unnecessary computation.

The server executes the above processes in a way that specifically improves the operation of the computer system. The combination of structured device registry, dynamic selection based on operation state information, and generative AI model-based semantic routing enables the server to avoid common inefficiencies such as sending all text tasks to a single engine or repeatedly invoking unsuitable services. The system reduces the need for human-designed routing rules, which are often brittle and difficult to maintain when new devices or services are added. Instead, the server uses internal prompt sentences, device scoring algorithms, and emotion-aware response adaptation to dynamically reconfigure the processing graph. This dynamic behavior, implemented in software but tightly coupled to hardware resource states, yields measurable improvements in processing speed, accuracy of task assignment, and resource utilization.

In another embodiment, the server employs alternative generative AI models, such as a smaller transformer model optimized for low-latency use or a model specialized for code generation or domain-specific terminology. The server can store multiple parameter sets for different models and select among them as processing targets using the same device registry and task classification method. The server can also integrate non-neural components, for example deterministic rule-based filters or finite-state automata, to pre-screen inputs and reduce the length of prompts, further improving throughput. The selection and orchestration framework remains the same, demonstrating that the invention is not limited to a specific neural architecture but provides a general computer-implemented mechanism for coordinating heterogeneous processing elements.

In still another embodiment, the server executes on a virtualized infrastructure, such as container-based instances orchestrated by a cluster manager. The server monitors resource metrics from multiple hosts and uses these metrics as part of the operation state information. By incorporating cluster-level load conditions into the selection algorithm, the server can shift intensive generative AI model tasks to nodes with available accelerator resources, thereby avoiding overload and thermal throttling. This embodiment emphasizes the technical benefit of improved hardware utilization and extended hardware lifespan by avoiding continuous operation at maximum load.

Through these embodiments, the server, the terminal, and the user interact in a structured manner where the server performs specific computations, uses well-defined data structures and neural network algorithms, and controls hardware resources in response to semantic and emotional analysis of prompt sentences. The resulting system is not limited to abstract information processing; rather, it provides concrete improvements to computer technology, including faster processing, more accurate routing and classification, improved data management, and reduced network and computation overhead, thereby enabling efficient and scalable deployment of generative AI models in real-world applications.

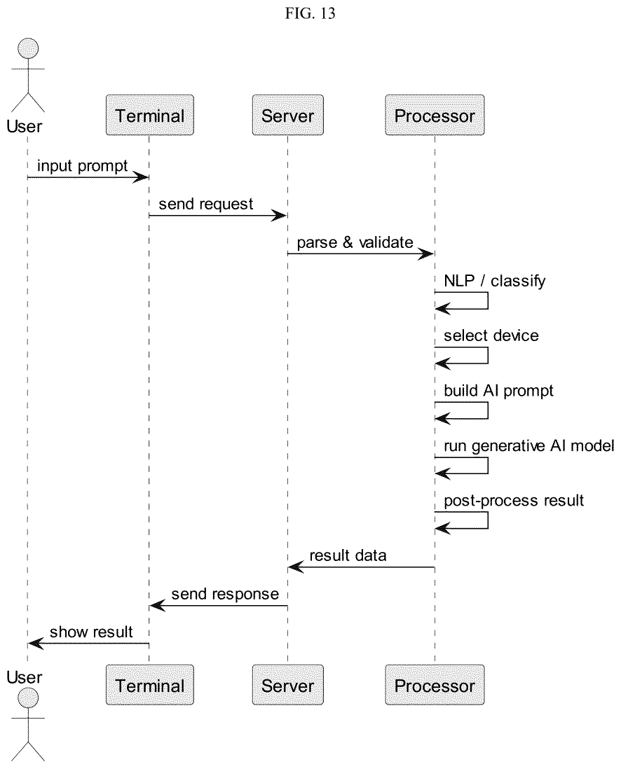

The following describes the processing flow using FIG. 13.

### Step 1:

The user operates the terminal to input a prompt sentence and associated data. The user types a prompt sentence such as “Please summarize the following report in about 150 English words.” or “Please recognize the objects in this image and describe them in simple English.” into an input field of an application running on the terminal, and optionally attaches text data or image data. The input of this step is the user's manual operation (keystrokes, touch input, file selection), and the output is raw user input data held in the terminal's memory, including at least the prompt sentence and any attached content.

### Step 2:

The terminal converts the raw user input data into a structured request message. The terminal creates a data structure containing fields such as user identifier, prompt sentence, content type (text or image), and the actual content payload (for example, the full report text or image binary). The terminal may also generate a timestamp and session identifier. The terminal performs data formatting operations, such as encoding text in UTF-8 and encoding image data as a binary stream or multipart body. The input of this step is the raw user input data from Step 1, and the output is a structured request message suitable for network transmission.

### Step 3:

The terminal transmits the structured request message to the server over a communication network. The terminal uses an HTTP or HTTPS client library to encapsulate the request message into an HTTP request, sets headers such as content type and authentication token, and sends the request to a predetermined server endpoint. The data processing here includes serialization of the structured request into a network packet sequence and encryption when HTTPS is used. The input of this step is the structured request message from Step 2, and the output is a network-transmitted request received at the communication interface of the server.

### Step 4:

The server receives the request and reconstructs the request data into internal objects. The server uses a web framework to parse the HTTP headers and body, separate metadata from payload, and instantiate internal data structures that represent the prompt sentence, user identifier, and attached content. The server also logs request metadata for monitoring. The input of this step is the raw network request packets received at the server's communication interface, and the output is a set of internal request objects stored in the server's memory.

### Step 5:

The server validates the internal request objects and identifies basic data types. The server checks that required fields such as the prompt sentence are present, verifies that file sizes do not exceed predetermined limits, and confirms that content types (for example, text/plain, image/jpeg) are consistent with the metadata. The server performs simple conditional checks and range checks as data operations. The input of this step is the internal request objects from Step 4, and the output is either a validated request object or an error status indicating invalid data; in the validated case, the output includes a classification of whether the content is text-only, image-only, or mixed.

### Step 6:

The server performs natural language preprocessing on the prompt sentence. The server passes the prompt sentence to a natural language processing program that tokenizes the text, performs part-of-speech tagging, and extracts key phrases. The server constructs feature vectors that may include token indices, n-gram counts, and pre-computed embeddings from a language model stored on the server. These operations involve table lookups, array indexing, and matrix multiplications for embedding lookup. The input of this step is the validated prompt sentence from Step 5, and the output is a structured representation of the prompt, including tokens, tags, and feature vectors.

### Step 7:

The server determines whether image data or other non-text data is present and classifies data types. The server inspects the request object to identify attached image files or other binary content. If image data exists, the server reads image metadata such as resolution, format, and file size, and records these attributes in a data type descriptor. The server may reduce resolution or compress the image if necessary, using image processing routines that resample pixel grids. The input of this step is the validated request object with attached content from Step 5, and the output is a data type descriptor specifying the presence and properties of text and image data.

### Step 8:

The server constructs an internal prompt sentence and uses a generative AI model to classify the task type. The server composes a textual internal prompt sentence such as “Classify the user's request into one task type. User prompt: ‘[user prompt sentence]’. Output exactly one label: [summarization, translation, style_conversion, sentiment_analysis, image_recognition, other].” The server tokenizes this internal prompt sentence and feeds the tokens as input to a generative AI model implemented as a transformer neural network. The processor performs matrix multiplications, attention computations, and softmax operations to compute a probability distribution over output tokens, and decodes the model's textual response to extract a label. The input of this step is the structured prompt representation from Step 6 and the data type descriptor from Step 7, and the output is a task type label stored as task type information.

### Step 9:

The server derives processing condition information from the prompt and, optionally, from the generative AI model. The server may generate another internal prompt sentence such as “Determine the desired output length, language, and style for the following user request: ‘[user prompt sentence]’. Answer in the format: length= . . . , language= . . . , style= . . . ” and send it to the generative AI model. The server parses the response and extracts specific parameters such as target word count, output language, and formality level. The server then stores these parameters in a processing condition structure. The input of this step is the structured prompt representation and task type information from Step 8, and the output is processing condition information specifying detailed constraints for subsequent processing.

### Step 10:

The server consults the device registry to determine candidate processing targets. The server accesses an information storage device that maintains attribute information, processing capability information, and operation state information for each electronic device and external function. The server performs database queries to retrieve records associated with devices that support the task type identified in Step 8. The server filters the results based on compatibility with the processing condition information and current operation state thresholds (for example, excluding devices with utilization above a certain level). The input of this step is the task type information and processing condition information, and the output is a list of candidate processing targets, each with associated capability and state metrics.

### Step 11:

The server selects an optimal processing target from the candidate list. The server computes a score for each candidate by applying a selection algorithm that may sum weighted factors such as estimated latency, estimated quality, and current load. The server may normalize these values and store them in an ordered data structure. The server chooses the candidate with the highest score that satisfies policy constraints. The mathematical operations include scaling, addition, and comparison over numeric values. The input of this step is the candidate list from Step 10, and the output is a selected processing target identifier, such as an endpoint URL or device ID.

### Step 12:

The server constructs a device-specific internal prompt sentence and request payload. For a text-oriented generative AI model, the server creates a system message and a user message that incorporate the task type and processing condition information. For example, the server creates an internal prompt sentence: “You are an expert summarization assistant. Summarize the following report in about 150 English words: [report text].” The server then formats this into the input structure required by the generative AI model, such as a sequence of token IDs and configuration parameters like maximum token count and temperature. For an image recognition device, the server constructs a request that includes image data and flags specifying object detection. The input of this step is the selected processing target identifier, the prompt sentence, the content data, and the processing condition information, and the output is a device-specific request payload ready for transmission.

### Step 13:

The server transmits the device-specific request payload to the selected processing target. The server uses a communication interface and a client library to send the payload to the processing target over a network, for example via an HTTP POST request to an API endpoint. The server may apply compression or chunking to large payloads and sets timeouts and retry conditions. The data operations include serialization of the request payload into a format such as JSON or binary protocol and encryption if a secure channel is used. The input of this step is the device-specific request payload from Step 12, and the output is a live remote call in progress, resulting in a response from the processing target.

### Step 14:

The selected processing target executes the requested information processing and returns processing result data to the server. When the target is a generative AI model, its processor executes transformer network operations to generate output text based on the internal prompt sentence and context. When the target is an image recognition engine, its processor applies convolutional or transformer-based layers to pixel data to detect and classify objects. Although these computations occur on the target side, from the server's perspective the input of this step is the transmitted request from Step 13, and the output is a response message received at the server, containing processing result data such as generated text or recognition results.

### Step 15:

The server parses and normalizes the processing result data. The server decodes the received payload, extracts the main result fields, and converts them into internal structures. For text outputs, the server may strip leading phrases, enforce length limits, and convert line breaks to a standard format. For recognition results, the server may convert a list of objects and confidence scores into a standardized object list structure. The operations include string manipulation, list traversal, and conditional formatting. The input of this step is the raw response message from the processing target in Step 14, and the output is normalized processing result data stored in the server's memory.

### Step 16:

The server performs optional multi-stage processing when multiple processing targets are involved. The server examines processing flow information to determine whether additional processing steps are required, such as further summarizing a long generated text or translating an intermediate result. If so, the server uses the normalized result as new input content, reconstructs a new device-specific internal prompt sentence or request payload, and repeats the selection and transmission steps for a subsequent target. The data operations include mapping fields from one internal structure to another and updating task type and processing condition information accordingly. The input of this step is normalized processing result data and processing flow information, and the output is either additional intermediate results or a final processed result suitable for presentation to the user.

### Step 17:

The server analyzes user emotion based on voice data and text data, if available. The server extracts acoustic features from voice signals, such as Mel-frequency cepstral coefficients, and text embeddings from user text messages, and feeds these feature vectors into an emotion classification model. The server executes the model, which computes logits and converts them to probabilities over predefined emotion classes via a softmax function. The server selects the highest-probability emotion class and, optionally, stores the entire probability distribution as emotion state information. The input of this step is user voice data and text data received in the same session, and the output is emotion state information associated with the current or future responses.

### Step 18:

The server adjusts the final response data in accordance with the emotion state information and the task type information. The server may modify internal prompt sentences for a last-stage generative AI call to increase or decrease explanation detail, change tone, or simplify terminology. For example, if the emotion state indicates confusion, the server may generate an internal prompt sentence: “Explain the following summary in a very simple and step-by-step manner suitable for a beginner: [summary text].” The server may also decide to truncate overly long results when the emotion state is neutral, to reduce cognitive load and network usage. The data operations involve editing text templates, updating processing condition parameters, and optionally invoking another generative AI call. The input of this step is the normalized processing result data and the emotion state information from Step 17, and the output is emotion-adjusted response data.

### Step 19:

The server constructs a final response message for the terminal. The server packages the emotion-adjusted response data into a structured response object, adds metadata such as task type, processing time, and any error codes, and serializes it into a format such as JSON. The server then sends this response object to the terminal via an HTTP or HTTPS response. The operations include object serialization, header setting, and network transmission. The input of this step is the emotion-adjusted response data from Step 18, and the output is a transmitted response message destined for the terminal.

### Step 20:

The terminal receives the final response message and renders the output for the user. The terminal parses the response body, extracts the main text or recognition results, and updates the user interface accordingly. For text summarization or translation, the terminal displays the resulting text in a text area. For image recognition, the terminal may overlay labels on the image and show corresponding descriptions. The terminal may also store the result locally for later reference. The input of this step is the response message from Step 19, and the output is a visual or auditory presentation of the result to the user on the terminal's display or speaker.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that invoke artificial intelligence models and external services in response to user inputs suffer from several technical shortcomings. First, such systems typically hard-code routing logic between a user interface and a fixed set of backend engines. As a result, the systems are unable to flexibly select among heterogeneous information processing resources in view of current load, historical reliability, and the semantic context of a user's prompt sentence. This rigid coupling leads to sub-optimal allocation of computational resources, increased latency, and reduced throughput at the server side.

Second, known systems usually treat a user's prompt sentence as an opaque string that is passed directly to one model or service, without performing structured natural language preprocessing and without constructing model-specific internal prompt sentences. Consequently, downstream generative artificial intelligence models often receive noisy or underspecified instructions, which increases the rate of incoherent or irrelevant outputs and forces repeated invocations. This degrades the effective accuracy and efficiency of the overall computing pipeline.

Third, existing architectures tend to integrate results from multiple models and services in an ad-hoc manner, for example by simply concatenating outputs or choosing an arbitrary result. They generally do not compute reliability indices or accuracy indices based on statistical analysis or trained evaluation models. Without such quantitative integration, the systems cannot systematically prioritize higher-quality results or adapt integration strategies as empirical performance data accumulates, thereby limiting the technical robustness of the server's decision-making process.

Fourth, typical systems either ignore a user's emotional state or handle it at the presentation layer only, without making the emotion signal a first-class input to the backend computation. In such systems, emotion analysis is not integrated into the routing, prompt construction, or response-generation logic. As a result, even if an emotion classifier is present, it does not effectively influence the selection of processing resources or the generation of responses, and the server cannot algorithmically adjust its behavior to mitigate user frustration or to reduce unnecessary follow-up exchanges. This leads to inefficient use of network and computing resources as the system engages in longer, less effective dialogues.

Fifth, conventional systems rarely employ closed-loop adaptation in which the server uses operation history information and user feedback as training data to refine its resource-selection policies and internal prompt construction policies. Without this type of dynamic optimization, the server cannot learn from previous interactions to improve routing decisions, to reduce redundant calls to large-scale models, or to adjust model selection in light of observed error patterns and user behavior. This lack of adaptive control diminishes the scalability and long-term performance of the system as usage grows.

Accordingly, there is a need for improved computer-implemented techniques that (i) perform structured natural language preprocessing of user prompt sentences, (ii) classify processing types and determine processing routes, (iii) select among multiple heterogeneous information processing resources using recorded attribute, performance, and usage information, (iv) construct internal prompt sentences tailored to subordinate generative artificial intelligence models, (v) integrate multiple processing results using statistical and learned evaluation techniques, (vi) estimate user emotion states from voice or text and adjust responses accordingly, and (vii) continuously refine routing and prompt policies based on historical operation data. Such techniques should improve the efficiency, reliability, and quality of server-side computation itself, rather than merely changing what content is shown to the user.

The specific processing by the specific processing unit 290 of the data processing device 12 in Application Example 2 is realized by the following means.

The present invention provides a server comprising a processor and an information storage unit, the processor being configured to manage, in an integrated manner, a plurality of information processing resources and a plurality of external processing functions by recording, in the information storage unit, attribute information, processing performance information, and usage status information of the plurality of information processing resources and the plurality of external processing functions; to receive, from a terminal device, input information including a prompt sentence, and perform natural language preprocessing on the input information to generate context information including at least morphological information, syntactic information, named expression information, and topic information; to classify a processing type of a user request based on the context information and determine a processing route including at least one of an information retrieval process, a summarization process, an explanation generation process, a recommendation process, an image generation process, and an emotion-responsive process; to select, based on the determined processing route and based on the attribute information, the processing performance information, and the usage status information recorded in the information storage unit, at least one processing resource from among the plurality of information processing resources and the plurality of external processing functions; to construct, based on the prompt sentence, the context information, and user attribute information, an internal prompt sentence to be input to a subordinate generative artificial intelligence model, and generate control information for transmitting the internal prompt sentence to the selected at least one processing resource; to collect a plurality of processing results obtained from at least one of the generative artificial intelligence model, a recommendation processing model, an image processing model, and an external business processing function, calculate at least one reliability index and at least one accuracy index for the plurality of processing results using a statistical analysis technique and a trained evaluation model, and integrate the plurality of processing results to generate an integrated result; to estimate emotion state information from user input by executing at least one of voice recognition processing and text analysis processing, and adjust a style, a tone, and content of a response message based on the emotion state information and the integrated result; to transmit the adjusted response message and the integrated result as output data to the terminal device; and to update, using operation history information and response evaluation information acquired from the terminal device as learning data, at least a resource-selection policy and an internal prompt-construction policy and dynamically optimize the determination of the processing route and the selection of the at least one processing resource for subsequent prompt sentences. This enables improvement of the technical operation of the server-side computing system by reducing unnecessary calls to backend resources, increasing effective accuracy and reliability of generated outputs through statistically guided integration, and adaptively tailoring routing and prompt construction based on linguistic context and user emotion, thereby enhancing computational efficiency, scalability, and robustness of the overall information processing pipeline.

The term “information processing resource” refers to a hardware or software computing component that receives input data, executes a predetermined computational process, and outputs a processing result, and includes, for example, a processing node, a processing module, or an artificial intelligence model.

The term “external processing function” refers to a processing capability provided by a system or service located outside the server, accessible via a communication network, and configured to execute a specific computational task in response to a request from the server.

The term “information storage unit” refers to a storage component, such as a memory device or a database system, that stores attribute information, processing performance information, usage status information, or other management information associated with the plurality of information processing resources and the plurality of external processing functions.

The term “attribute information” refers to descriptive data indicating characteristics of an information processing resource or an external processing function, including at least a type, a supported task category, and an interface specification.

The term “processing performance information” refers to quantitative or qualitative data indicating computational capability of an information processing resource or an external processing function, including at least latency, throughput, and resource consumption characteristics.

The term “usage status information” refers to information representing a current or recent utilization state of an information processing resource or an external processing function, including at least load level, availability, and error status.

The term “terminal device” refers to an end-user computing apparatus configured to transmit input information including a prompt sentence to the server and to receive and present output data from the server, and includes, for example, a portable terminal, a stationary terminal, or a wearable terminal.

The term “prompt sentence” refers to a sequence of natural language characters or symbols input by a user to request a task or information from the system, and serving as a trigger for processing by a generative artificial intelligence model or other information processing resources.

The term “natural language processing” refers to a computational technique for analyzing and handling human language expressions, including at least tokenization, morphological analysis, syntactic parsing, named entity recognition, and topic extraction.

The term “context information” refers to structured data derived from the prompt sentence and related input information, and including at least morphological information, syntactic information, named expression information, topic information, or other semantic indicators used to infer a processing type.

The term “morphological information” refers to information representing word-level features of the prompt sentence, including at least word boundaries, base forms, and part-of-speech categories.

The term “syntactic information” refers to information indicating grammatical relations within the prompt sentence, including at least phrase structures, dependency relations, and clause boundaries.

The term “named expression information” refers to information identifying words or phrases corresponding to specific entities, such as persons, organizations, locations, products, or technical terms, extracted from the prompt sentence.

The term “topic information” refers to information indicating one or more subject matters or themes inferred from the prompt sentence, such as domains, intents, or categories relevant to the requested processing.

The term “processing type” refers to a classification label indicating a kind of computational operation to be performed for a user request, and includes, for example, an information retrieval process, a summarization process, an explanation generation process, a recommendation process, an image generation process, or an emotion-responsive process.

The term “processing route” refers to a logical sequence or combination of one or more processing steps and information processing resources determined for handling a specific user request on the basis of the context information.

The term “generative artificial intelligence model” refers to an artificial intelligence model configured to generate output data, such as text, images, or other media, in response to input data including a prompt sentence, by using a learned statistical or neural network-based generation mechanism.

The term “internal prompt sentence” refers to a machine-oriented instruction string constructed by the server on the basis of the user's prompt sentence, context information, and user attribute information, and adapted for input into a subordinate generative artificial intelligence model or other processing resource.

The term “control information” refers to data generated by the server that specifies at least a target information processing resource and an internal prompt sentence, and is used to cause execution of processing by the target information processing resource.

The term “recommendation processing model” refers to an information processing resource configured to compute one or more recommendation results, such as content items or products, based on user-related information, context information, or historical data.

The term “image processing model” refers to an information processing resource configured to analyze, transform, or generate image data, including at least an image recognition model or an image generation model.

The term “external business processing function” refers to an external processing function that executes a domain-specific business operation, such as transaction processing, logistics tracking, or content retrieval, in response to a request from the server.

The term “processing result” refers to data output from an information processing resource or an external processing function after execution of a requested computational operation.

The term “statistical analysis technique” refers to a computational method for evaluating data using statistical principles, and includes, for example, regression analysis, Bayesian estimation, or probabilistic scoring.

The term “trained evaluation model” refers to a machine-learned model that receives one or more processing results or related features as input and outputs an evaluation measure, such as a reliability index or an accuracy index, based on parameters obtained through training on example data.

The term “reliability index” refers to a numerical or categorical measure indicating a degree of trustworthiness or consistency of a processing result produced by an information processing resource or an external processing function.

The term “accuracy index” refers to a numerical or categorical measure indicating a degree of correctness or closeness to an expected target of a processing result produced by an information processing resource or an external processing function.

The term “integrated result” refers to a combined output generated by the server through integration of a plurality of processing results and selection or synthesis of a final result according to at least one reliability index and at least one accuracy index.

The term “emotion state information” refers to data representing an estimated emotional condition of a user, such as frustration, satisfaction, fatigue, or neutrality, derived from analysis of user input.

The term “voice recognition processing” refers to a computational process that converts an acoustic signal produced by a user into text data or other symbolic representations.

The term “text analysis processing” refers to a computational process that analyzes textual user input to extract features, including at least sentiment features, emotional cues, or semantic indicators.

The term “response message” refers to textual content generated by the server as a reply to a user request, optionally including explanatory information, recommended items, or guidance information.

The term “output data” refers to information transmitted from the server to the terminal device, including at least the response message, the integrated result, and any associated metadata or resource identifiers.

The term “user attribute information” refers to information associated with a user, such as profile data, preference data, or historical interaction data, used to customize processing or responses.

The term “operation history information” refers to recorded data describing past interactions of a user or terminal device with the system, including at least issued prompt sentences, selected processing routes, and invoked processing resources.

The term “response evaluation information” refers to feedback data representing a user's reaction or assessment of a response result, such as explicit ratings, implicit behavior signals, or error reports.

The term “resource-selection policy” refers to a set of rules, parameters, or learned models used by the server to decide which information processing resources or external processing functions to select for a given processing type or context.

The term “internal prompt-construction policy” refers to a set of rules, templates, or learned models used by the server to determine how to form an internal prompt sentence from a prompt sentence, context information, and user attribute information.

The term “response function group” refers to a set of different response-generation functions implemented in the system, including at least a complaint-handling dialogue function, a comfort-enhancement content provision function, and an explanation-oriented dialogue function.

The term “complaint-handling dialogue function” refers to a response function configured to generate dialogue content that addresses user complaints or dissatisfaction in a problem-solving and empathetic manner.

The term “comfort-enhancement content provision function” refers to a response function configured to provide content intended to improve or stabilize a user's emotional state, such as relaxation-oriented or reassuring content.

The term “explanation-oriented dialogue function” refers to a response function configured to generate detailed explanatory dialogue content aimed at clarifying information, procedures, or reasons in response to a user request.

The term “response candidate” refers to a provisional response message generated by a response function or a generative artificial intelligence model before selection as a final response.

The term “final response” refers to a response message determined by the server, after evaluation and selection among one or more response candidates and the integrated result, as output to be transmitted to the terminal device.

In one embodiment, a server comprises a processor, a memory subsystem, a non-volatile storage device, and a network interface, and a terminal comprises a processor, a memory, an input/output interface including at least a display device and an audio input device, and a communication interface. The server executes a program stored in the non-volatile storage device to implement the functions described in the claims.

The server uses the memory subsystem to store an information storage unit implemented as a database. The server implements the database using, for example, a relational database system executing on the same physical machine or on a separate storage node. The server records, in the database, attribute information, processing performance information, and usage status information for a plurality of information processing resources and a plurality of external processing functions. The server represents each information processing resource by an entry including fields such as resource identifier, supported task categories, model type (for example, sequence-to-sequence model, encoder-decoder model, convolutional neural network, or transformer-based model), approximate latency in milliseconds, throughput in requests per second, and recent error rate. The server represents each external processing function by an entry including at least an endpoint address, protocol, expected response time, and functional description.

The server uses a natural language processing module running on the processor to parse and analyze a prompt sentence received from the terminal. The server implements the natural language processing module using a software library capable of tokenization, part-of-speech tagging, dependency parsing, named entity recognition, and topic classification. The server stores the prompt sentence as a character sequence in memory, converts it into tokens, and assigns part-of-speech tags by executing a trained tagging model. The server constructs a dependency tree, identifies named expressions corresponding to entities such as products, locations, or technical terms, and determines topic information by applying a classifier model trained on domain-specific corpora. The server packs these features into a structured data object, for example a record containing lists of tokens, part-of-speech tags, dependency edges, entity spans, and topic labels, and stores this object as context information for the prompt sentence.

The server classifies a processing type for each user request based on the context information. The server executes a multi-class classifier implemented as a neural network that takes, as input, vector representations of the prompt sentence and outputs probabilities over processing types such as information retrieval, summarization, explanation generation, recommendation, image generation, and emotion-responsive processing. The server may implement the classifier as a transformer-based encoder followed by a dense layer with softmax activation.

The server computes an embedding of the prompt sentence by averaging or pooling token embeddings, feeds the embedding to the dense layer, and selects the processing type with the highest probability. The server records the selected processing type in a processing route descriptor stored in memory.

The server determines a processing route by mapping the processing type and topic information to a sequence of internal modules and information processing resources. The server uses rule sets stored in the database to map combinations of processing type and topic to recommended resource chains. For example, the server maps a processing type “summarization” with topic “news” to a route including a transformer-based summarization model and a reliability evaluator. The server maps a processing type “image generation” with topic “scene description” to a route including a text encoder and an image generation neural network.

The server selects at least one processing resource based on the processing route and the stored attribute information, processing performance information, and usage status information. The server executes a selection algorithm that non-trivially optimizes for latency and expected accuracy. For example, the server computes a score S for each candidate resource as a function of its historical accuracy A, inverse latency L, and current utilization U according to S=α·A+β·L−γ·U, where α, β, and γ are configuration parameters stored in the database. The server sorts candidate resources by the score and chooses the highest-scoring resource that satisfies availability constraints. The server thereby improves resource allocation beyond simple round-robin or human-defined static routing, directly enhancing server-side performance.

The server constructs an internal prompt sentence tailored to a subordinate generative AI model. The server implements a prompt construction module that takes, as input, the original prompt sentence, context information, user attribute information, and processing type. The server uses templates and transformation rules stored in the database to inject additional instructions, constraints, and formatting into the internal prompt sentence. For a text-generating model, the server may prepend role instructions, content boundaries, and tone requirements. For an image-generating model, the server may expand sparse user descriptions into more detailed image specifications by adding inferred attributes or style descriptors.

For example, when a user inputs the prompt sentence:
“Please tell me about the latest technologies that might interest me.”
the server augments this prompt with topic information and user preferences to generate an internal prompt sentence such as:
“The user is interested in recent advances in information technology. Provide a concise explanation of three emerging technologies and relate them to the user's interest profile.”

In another example, when a user inputs the prompt sentence:
“Please summarize the following sentence: ‘AI technology is rapidly evolving.’” the server constructs an internal prompt sentence:
“Summarize the following sentence in one short phrase preserving the main idea: ‘AI technology is rapidly evolving.’”

For image generation, if a user inputs the prompt sentence:
“Generate an image of a red house standing under a blue sky.”
the server constructs an internal prompt sentence:
“Generate a high-resolution illustration of a small red house standing alone in a wide field under a bright blue sky, daytime, minimalistic style.”

The server invokes a generative AI model by sending the internal prompt sentence to a neural network executed either locally or on an external processing device. The server may implement the generative AI model as a transformer-based language model for text generation or as a diffusion-based model for image generation. For text, the server converts tokens into embeddings, passes them through multiple self-attention layers, and decodes the output distribution token by token using an autoregressive mechanism. For images, the server encodes the internal prompt sentence into a latent conditioning vector and iteratively refines a noise vector into an image through a learned denoising process. The server thus performs specific data transformations and numerical operations determined by trained model parameters, rather than merely forwarding text from the user.

The server uses the information storage unit to manage parameters for the generative AI model, such as maximum output length, sampling temperature, and decoding strategy. The server adjusts these parameters dynamically based on processing type and detected emotion state to maintain a balance between response diversity and determinism. This dynamic parameter control changes the behavior of the underlying generators in a technically meaningful way and can reduce both average response time and error rate by avoiding excessively long or unstable generations.

The server collects processing results from multiple information processing resources, including generative AI models, recommendation models, image processing models, and external business systems. The server stores these results as structured records including fields for result content, source identifier, model version, and confidence score. The server passes these records to an integration module implemented as a machine-learned evaluation model. The evaluation model is, in one embodiment, a neural network that receives feature vectors describing each candidate result, such as length, lexical overlap with the input, consistency with known facts, and internal model confidence. The evaluation model outputs a quality score or ranking for each candidate result.

The server trains the evaluation model offline using supervised learning. The server collects historical interaction logs containing candidate results and user feedback, such as explicit ratings or implicit behaviors (for example, whether the user requested a correction). The server defines a loss function, such as cross-entropy or a pairwise ranking loss, reflecting the discrepancy between predicted quality scores and feedback-derived labels. The server updates weights of the evaluation model using gradient-based optimization, such as stochastic gradient descent or an adaptive variant, to reduce the loss over training iterations. By deploying the trained evaluation model online, the server integrates multiple processing results in a principled way, improving selection of high-quality outputs and lowering the observed error rate.

The server computes a reliability index and an accuracy index for each candidate result by combining outputs of the evaluation model with statistical analysis, for example Bayesian updating using prior reliability estimates for each resource and empirical error statistics. The server then integrates the candidate results into an integrated result by selecting the top-ranked answer, merging complementary information, or constructing a composite response that combines text explanations with recommended items. Because the integration uses quantitative indices and learned evaluation, the server can reduce inconsistent or redundant outputs and improve overall system robustness.

The server estimates emotion state information from user input. The server implements an emotion recognition module that receives either text transcribed from the user's voice or text typed by the user. The server converts each prompt sentence into an embedding and feeds it to a classifier network trained to distinguish emotional categories such as frustration, fatigue, or neutrality. The server may use features such as sentiment polarity, intensity of negative terms, punctuation patterns, and dialogue history. When the server receives spoken input, the server first invokes a speech-to-text module implemented as an acoustic model and a language model. The acoustic model processes sampled waveforms through convolutional and recurrent layers to produce phoneme distributions, and the language model resolves these into text sequences. The server passes the resulting text to the emotion recognition module. The server adjusts style, tone, and content of a response message based on the estimated emotion state information and the integrated result. For example, when the emotion state indicates frustration, the server selects a complaint-handling dialogue function from a response function group. The server then constructs a new internal prompt sentence that instructs the generative AI model to generate a polite and empathetic explanation, such as: “A user wrote: ‘This service is absolutely useless.’ The user is angry and frustrated. Generate a polite, empathetic response that acknowledges the frustration, apologizes, and asks for the necessary information to investigate the problem.”

The server thus uses emotion as a control signal not merely at the user interface, but inside the computational pipeline that constructs internal prompt sentences and chooses response functions. This interaction between emotion estimation and model control yields shorter resolution dialogues and reduces repeated exchanges, which in turn lowers network and compute load.

The server updates resource-selection policies and internal prompt-construction policies over time. The server records operation history information, including which resources were selected, how long they took to respond, what quality scores were computed, and what user feedback was observed. The server also records response evaluation information, which may derive from explicit user ratings, click-through on recommended items, or manually reported errors. The server uses this historical data to retrain parameters of the selection algorithm and prompt construction templates. For example, if a particular summarization model consistently yields lower quality scores or higher correction rates, the server reduces its selection weight. If users respond positively to more concise internal prompts in certain domains, the server shortens prompt templates for those domains. This closed-loop learning modifies server behavior at the algorithmic level and improves computing efficiency and accuracy beyond static, human-defined configurations.

The terminal serves as an endpoint for user interaction and as a conduit for data exchange with the server. The terminal displays a user interface that allows the user to input prompt sentences by keyboard, touchscreen, or voice input. The terminal executes software that captures voice signals via a microphone, digitizes them, and, in some variants, performs preliminary noise reduction before sending them to the server. The terminal constructs a message packet including the prompt sentence, user identifier, device characteristics, and optional context information such as time or location. The terminal transmits the packet to the server over a network using a communication protocol such as HTTPS.

The terminal receives response messages and associated integrated results from the server, parses them, and updates the display. The terminal presents generated text in a dialogue container, displays recommended items in ranked lists with thumbnails, and displays images produced by the generative AI model in an image viewing component. The terminal may also play audio content, such as relaxation music recommendations, through speakers or headphones. In certain embodiments, when the server selects a comfort-enhancement content provision function, the server transmits identifiers for multimedia content, and the terminal retrieves the content from a content delivery node and renders it. Thus, the system is not limited to abstract text manipulation; it controls actual media rendering on physical devices in accordance with computed decisions.

The user activates the system by operating the terminal. The user enters prompt sentences requesting various tasks, such as:
“Please tell me about the latest technologies that might interest me.”
“Please summarize the following sentence: ‘AI technology is rapidly evolving.’”
“Generate an image of a red house standing under a blue sky.”
“I want to check the delivery status of my product; it still hasn't arrived.”
“This service is absolutely useless.”

The user reads or views the server's responses on the terminal and may provide further input or feedback. The user can, for example, indicate satisfaction, request clarification, or report that the response was unhelpful. The server incorporates this feedback into operation history information.

The system as a whole yields technical effects within the computer environment. Because the server performs structured natural language preprocessing, context-based processing type classification, and optimized resource selection, the server reduces redundant invocations of high-cost generative AI models and shortens average processing time. Because the server uses an evaluation model and statistical integration, the system reduces the frequency of low-quality responses and associated corrective exchanges, improving effective throughput. Because the server uses emotion state information as a control input for routing and prompt construction, the system reduces unnecessary iterative dialogues and adapts message length and tone to user state, decreasing bandwidth consumption and server load. The adaptive updating of selection and prompt policies based on logged performance data further improves resource utilization and stability over time.

These improvements are not mere automation of human judgment, because a human operator cannot manually maintain or execute, in real time, the multi-dimensional optimization over performance metrics, model parameters, and emotion states for each user request. The server executes defined algorithms for scoring and selecting resources, for constructing internal prompt sentences based on structured context and user attributes, and for integrating multiple candidate outputs using learned evaluation models and statistical analysis. The system thereby modifies how the computer allocates memory and processor time to heterogeneous models, how the computer structures instructions to those models, and how the computer merges their outputs, resulting in concrete improvements in speed, accuracy, and resource efficiency of the computing system itself.

Alternative embodiments are possible. The server may implement the information storage unit using a key-value store instead of a relational database, while maintaining the same fields and data structures. The server may implement the natural language processing module with different architectures, such as a recurrent neural network or a hybrid rule-based and neural system. The server may implement the evaluation model as a gradient-boosted decision tree model instead of a neural network, while still computing reliability and accuracy indices. The emotion recognition module may use additional modalities, such as facial expressions captured from a camera, with feature extraction performed by a convolutional neural network. The processing routes may include additional processing types, such as code generation or tabular data analysis, with corresponding resources stored in the information storage unit.

In all such embodiments, the common core is that the server uses structured representations of prompt sentences, quantitative performance data for multiple resources, and emotion state information to control an internal pipeline of generative and analytic models in a way that improves the technical operation of the computing infrastructure, increases processing accuracy, and reduces wasted computational and communication resources, while enabling the user, through the terminal, to obtain context-appropriate responses generated by at least one generative AI model in response to a prompt sentence.

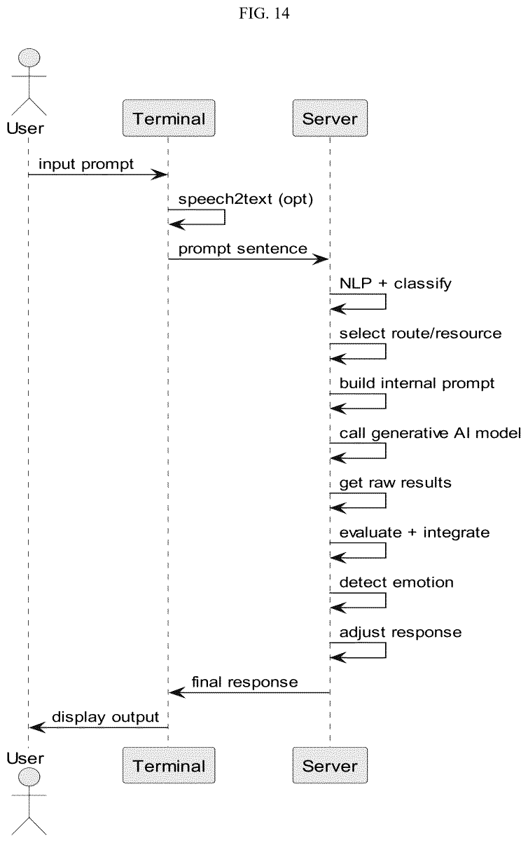

The following describes the processing flow using FIG. 14.

### Step 1:

User operates the terminal and inputs a prompt sentence by keyboard, touch interface, or voice.

User provides, as input, natural language text or speech that expresses a request (for example, “Please tell me about the latest technologies that might interest me.”).

Terminal receives the input, digitizes audio signals if present, and stores the raw text or audio stream in working memory as the output of this step.

### Step 2:

Terminal converts any audio input into text and prepares a request message.

Terminal takes, as input, the audio stream from Step 1 and applies a speech-to-text engine to perform feature extraction, acoustic modeling, and language modeling to generate a text transcription.

Terminal combines the resulting text (or directly entered text) with metadata such as user identifier, device type, and timestamp, and constructs a structured request object.

Terminal outputs this request object and sends it via a network protocol to the server.

### Step 3:

Server receives the request object and performs validation and logging.

Server takes, as input, the structured request object from the terminal, checks required fields (prompt sentence, user identifier), and discards or flags malformed requests.

Server writes the validated prompt sentence, user identifier, and metadata into a log table of an information storage unit, thereby generating a stored log record as the output of this step.

### Step 4:

Server executes natural language preprocessing to generate context information.

Server takes, as input, the prompt sentence text from the request, and applies a natural language processing module to perform tokenization, part-of-speech tagging, syntactic parsing, and named entity recognition.

Server computes, through these data transformations, lists of tokens, tags, dependency relations, entity spans, and topic labels, and groups them into a context information structure. Server outputs the context information object and associates it with the original prompt in memory.

### Step 5:

Server classifies the processing type based on the context information.

Server uses, as input, the context information from Step 4 and converts the prompt sentence into a numerical vector representation using an embedding model.

Server feeds this vector into a trained classifier network that performs matrix multiplications and non-linear activations to compute probability values for each processing type (for example, summarization, recommendation, image generation).

Server selects the processing type with the highest probability and outputs a processing type label and confidence score.

### Step 6:

Server determines a processing route corresponding to the processing type and topic.

Server receives, as input, the processing type label and topic information, and consults a rule set and configuration tables stored in the information storage unit.

Server performs table lookups and conditional evaluations to map the pair (processing type, topic) to a sequence of internal modules and candidate information processing resources.

Server outputs a processing route descriptor that lists required operations and eligible resources for this request.

### Step 7:

Server selects one or more information processing resources using recorded performance and usage data.

Server takes, as input, the processing route descriptor and management data for all available resources, including attribute information, performance metrics, and current usage status. Server computes, for each candidate resource, a numerical score using a weighted formula that combines historical accuracy, inverse latency, and utilization, and then sorts the candidates by score.

Server chooses the top-ranked resource or resource set that meets availability constraints, and outputs a selected-resource list that specifies the identifiers and endpoints of the chosen resources.

### Step 8:

Server constructs an internal prompt sentence for each selected generative AI model.

Server uses, as input, the original prompt sentence, the context information, the user attribute information, and the selected-resource list.

Server applies template rules, string concatenation, and insertion of control phrases (for example, specifying tone, length, or style) to transform the user-level prompt into a model-oriented internal prompt.

Server outputs one or more internal prompt sentences, each tagged with a target generative AI model or other processing resource.

### Step 9:

Server invokes the selected generative AI models and other processing resources.

Server takes, as input, the internal prompt sentences and the selected-resource list, and for each resource constructs a request payload in the required format (for example, token IDs for a text generator or conditioning vectors for an image generator).

Server sends these payloads to local or remote processing engines, which execute neural network forward passes consisting of vector multiplications, attention operations, activation functions, and decoding algorithms.

Server receives generated texts, images, recommendations, or factual data as outputs from these engines and stores them as a set of raw processing results.

### Step 10:

Server evaluates and integrates multiple processing results into an integrated result.

Server uses, as input, the raw processing results along with resource identifiers, confidence estimates, and context information.

Server extracts numerical and symbolic features from each result (such as length, semantic similarity to the prompt, and source reliability statistics) and feeds them into a trained evaluation model or applies statistical formulas.

Server computes reliability indices and accuracy indices, ranks or combines the candidate results according to these indices, and outputs a single integrated result that represents the best or optimally merged output for the request.

### Step 11:

Server estimates the user's emotion state from the input and previous interactions.

Server takes, as input, the user text (and optionally transcribed speech), as well as dialogue history features, and converts these into numerical feature vectors capturing sentiment scores, intensity of emotional words, and punctuation patterns.

Server applies an emotion classification model that performs matrix operations and activation functions to output probabilities for different emotion classes, and then selects the most likely emotion.

Server outputs emotion state information consisting of an emotion label and an associated confidence value.

### Step 12:

Server adjusts the response message style, tone, and content based on emotion and the integrated result.

Server uses, as input, the integrated result from Step 10 and the emotion state information from Step 11.

Server either applies rule-based transformations (for example, adding apologies or reassurance phrases) or constructs a secondary internal prompt sentence instructing a generative AI model to rephrase or expand the integrated result in a tone that matches the detected emotion.

Server generates an adjusted response message that preserves the factual content of the integrated result while modifying wording and structure, and outputs this adjusted response message.

### Step 13:

Server assembles the final response and transmits it to the terminal.

Server takes, as input, the adjusted response message, any auxiliary data such as links to generated images or recommended items, and metadata including timestamps and confidence scores.

Server formats this data into a response object, serializes it into a network message, and sends it through the network interface to the terminal.

Server outputs the transmitted response as the final product of the server-side processing for the given prompt sentence.

### Step 14:

Terminal receives the final response and updates the user interface.

Terminal uses, as input, the response object from the server, parses the contained text, media references, and metadata, and maps them to user interface elements.

Terminal renders the generated text in a display area, shows images produced by the generative AI model, lists recommended items, and optionally plays audio content, thereby performing graphical and audio output operations.

Terminal outputs visual and auditory signals that the user can perceive as the system's response.

### Step 15:

User reviews the response and optionally provides feedback or a follow-up prompt sentence. User observes, as input, the displayed or played content, evaluates its usefulness or correctness, and may perform concrete actions such as clicking, liking, ignoring, or entering another prompt sentence (for example, “Please summarize this further.”).

User interactions become output signals for the terminal, which can be recorded as feedback data and sent back to the server in subsequent cycles, enabling adaptive refinement of resource selection and prompt construction in later executions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

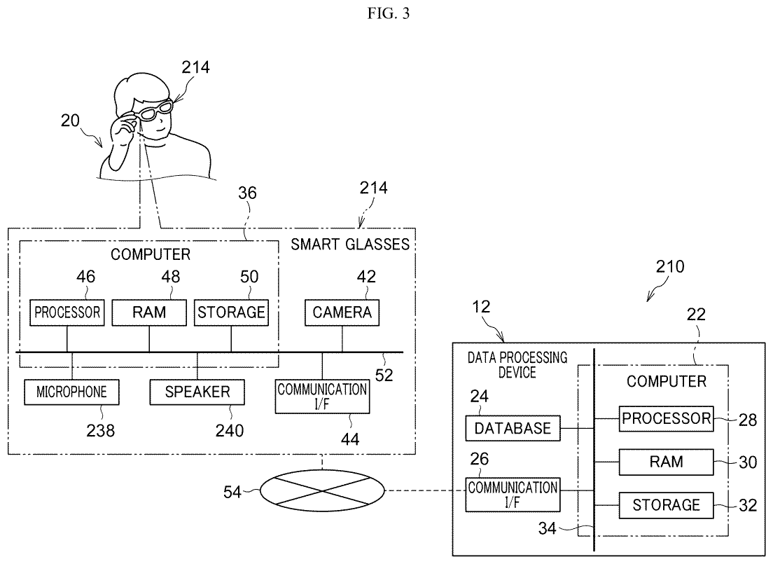

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

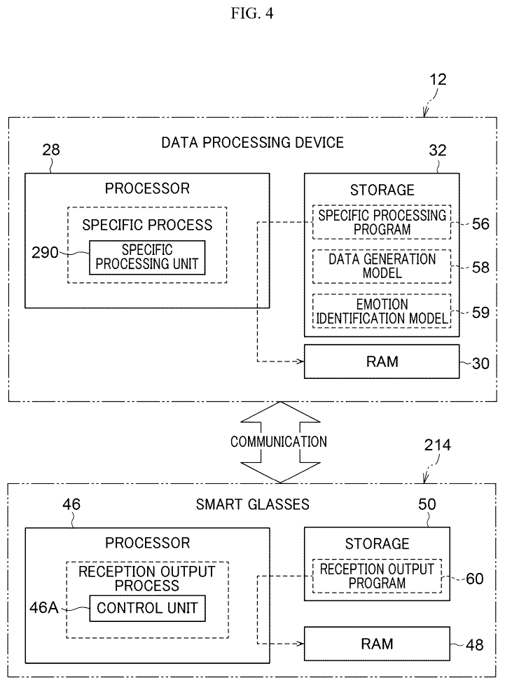

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

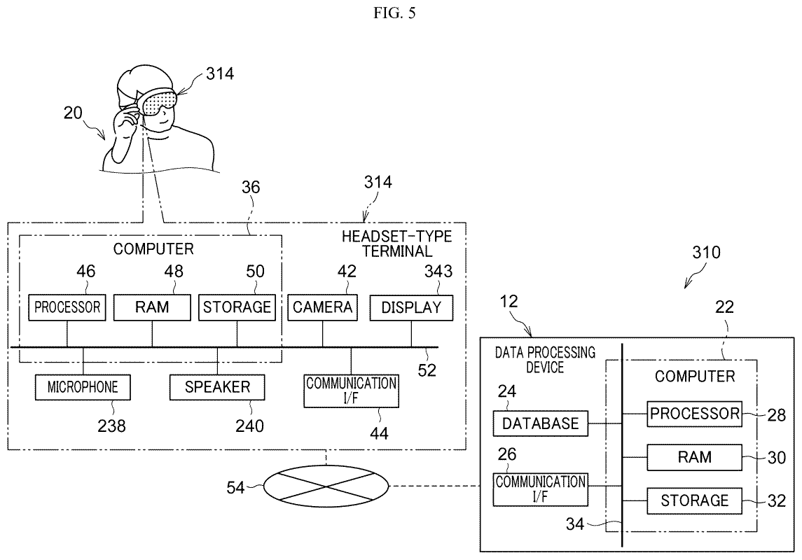

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

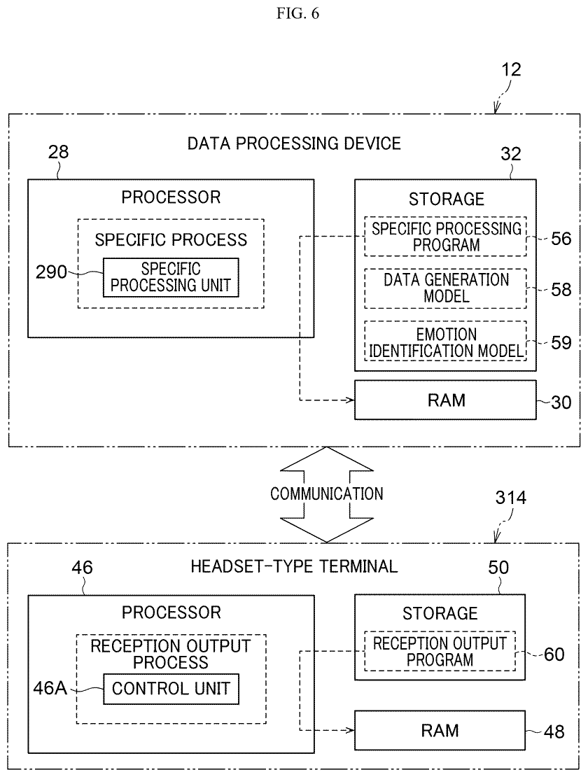

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

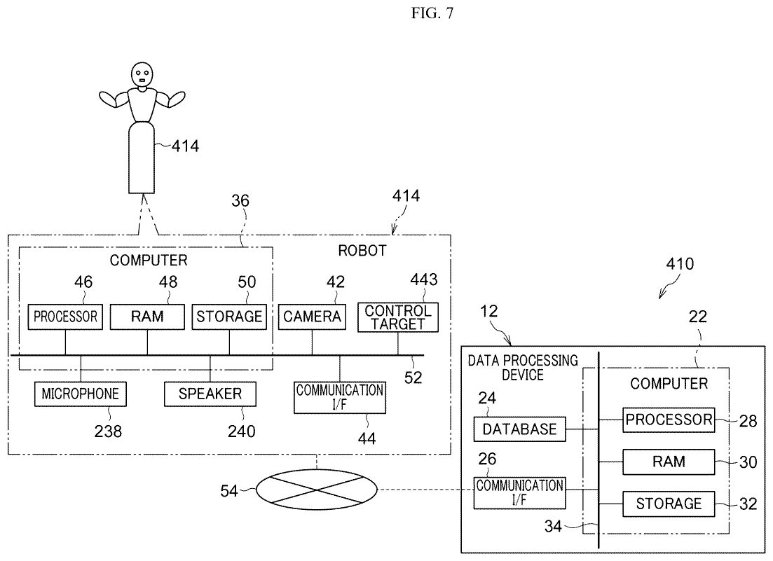

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

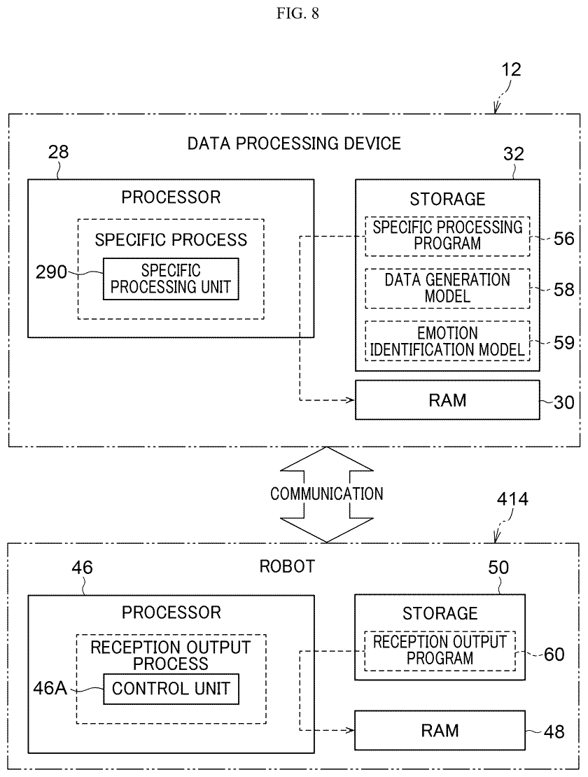

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

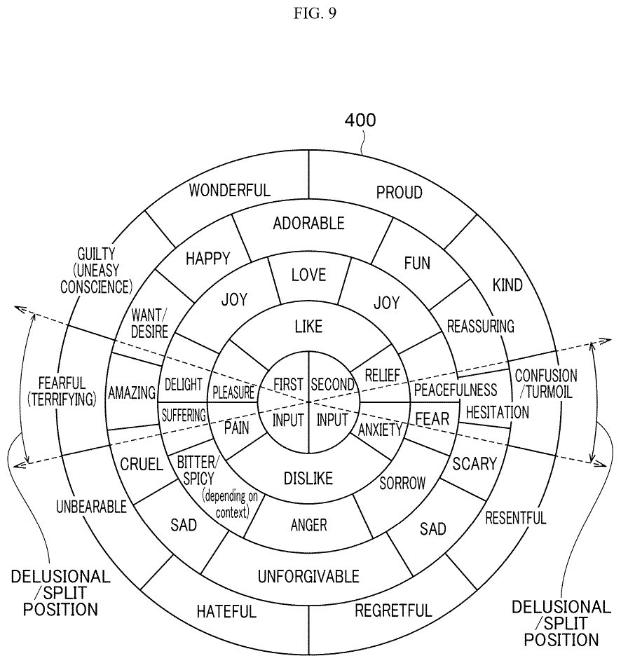

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

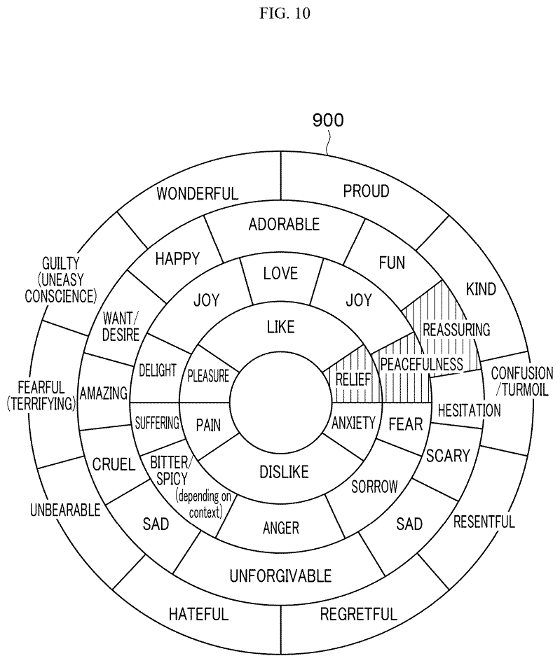

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
use an information storage element that collectively records type information, processing capability information, and usage state information regarding a plurality of information processing elements and external function elements, and centrally manage the plurality of information processing elements and the external function elements based on the recorded information,
acquire text information of a prompt sentence transmitted from a use terminal, perform preprocessing including character code conversion, removal of unnecessary characters, and
format normalization on the prompt sentence, analyze contextual information of the prompt sentence by using a natural language processing technique, and extract requirement condition information including task type, output format, and constraint condition,
calculate, for each of the plurality of information processing elements, a suitability index by performing weighted arithmetic on a processing speed index, an accuracy index, and a resource utilization index based on the requirement condition information and the type information, the processing capability information, and the usage state information recorded in the information storage element, and select an optimal information processing element and/or an optimal external function element based on the suitability index,
transmit processing request information including the prompt sentence and the requirement condition information to the selected information processing element and/or the selected external function element, cause a generative artificial intelligence model executed on the selected information processing element or the selected external function element to receive the prompt sentence as input, and cause the generative artificial intelligence model to perform information processing including at least one of text generation processing, summarization processing, translation processing, question answering processing, and data analysis processing,
acquire a plurality of processing results from the information processing element and/or the external function element, perform inspection processing regarding output format conformity, language type, and satisfaction of structural requirements, calculate a reliability index and an accuracy index for the plurality of processing results by using a statistical technique or a machine learning technique, and select or integrate the plurality of processing results based on the indices to generate a single integrated result, and
format the integrated result into a data structure transmittable to the use terminal and transmit the integrated result to the use terminal through communication control processing.

### (Supplementary 2)

The system according to supplementary 1,
wherein the processor is configured to
append operational performance information including time-varying processing time information, error occurrence information, and user evaluation information to the type information, the processing capability information, and the usage state information recorded in the information storage element, update weight coefficients used in the arithmetic of the suitability index based on the operational performance information, and thereby dynamically adjust a selection logic for the generative artificial intelligence model.

### (Supplementary 3)

The system according to supplementary 1,
wherein the processor is configured to
store, in an anonymous manner, history information associated with the prompt sentence and the integrated result in a log storage element, and retrain at least one of a task type discrimination model used in the natural language processing technique and a machine learning model used for calculation of the suitability index by using the history information, thereby improving selection accuracy of the information processing element and quality of the processing result for a subsequent prompt sentence.

### Application Example 1

### (Supplementary 1)

A system comprising a processor,
wherein the processor is configured to
record and update, in a storage unit, management information for a plurality of information processing units, the management information including type information, processing capability information, load state information, and usage history information of each of the plurality of information processing units,
receive a prompt sentence input by a user, and analyze the prompt sentence by using a natural language processing technique and a generative AI model so as to convert the prompt sentence into structured parameters including at least a task type, a performance requirement, a time constraint, a target facility, and a target period,
calculate, on the basis of the structured parameters and the management information, a suitability index for each of the plurality of information processing units, and select, on the basis of the suitability index, one or more information processing units or external functions that satisfy at least the task type and the performance requirement,
generate, for each selected information processing unit or external function, a control message including an instruction content generated from the prompt sentence and the structured parameters by using the generative AI model, and transmit the control message via a communication unit so as to cause execution of a task corresponding to the prompt sentence,
collect processing results acquired from the information processing units or the external functions, calculate, by using a statistical technique or a machine learning technique, a reliability index and an accuracy index for the processing results, and integrate the processing results on the basis of the reliability index and the accuracy index to generate an integrated result on a task basis and summary information corresponding to the integrated result, and output the integrated result and the summary information to a terminal via a user interface, analyze an emotional state of the user on the basis of voice data and text data acquired from the user, and adjust at least one of expression content and presentation format of the summary information in accordance with an analysis result of the emotional state.

### (Supplementary 2)

The system according to supplementary 1,
wherein the processor is configured to
store, as configuration information in the storage unit, task classification information, evaluation criteria, and weighting coefficients corresponding to the task type and the performance requirement included in the structured parameters, and change, on the basis of the configuration information, at least one of a calculation method of the suitability index and a selection criterion of the information processing units.

### (Supplementary 3)

The system according to supplementary 1,
wherein the processor is configured to
calculate, for each of the information processing units or the external functions, the reliability index and a weight on the basis of past processing history and a dependency on the task type, generate the integrated result on the basis of the reliability index and the weight, and input the integrated result and the structured parameters to the generative AI model so as to automatically generate a human-readable explanatory text.

### Example 2

### (Supplementary 1)

A system comprising a processor,
wherein the processor is configured to
record and refer to attribute information, processing capability information, and operation state information of a plurality of electronic devices in an information storage device so as to centrally manage the plurality of electronic devices,
acquire natural language data or image data including a prompt sentence input from a terminal, analyze context information of the prompt sentence and data type information by using a natural language processing program and an image processing program, and structure an analysis result as task type information and processing condition information,
select, on the basis of the task type information, the processing condition information, and the attribute information, processing capability information, and operation state information of the plurality of electronic devices, at least one processing target from among the plurality of electronic devices and external functions,
generate an internal prompt sentence to be input to a generative artificial intelligence model for the selected processing target, transmit a request including the internal prompt sentence to the selected processing target, and cause execution of information processing including at least one of text summarization, translation, style conversion, and object recognition, receive processing result data from the selected processing target, normalize and format-convert the processing result data, or integrate a plurality of pieces of processing result data, and generate response data that is transmittable to the terminal,
analyze voice data and text data input from a user to extract emotion state information, and adjust content, expression style, and level of detail of the response data in accordance with the emotion state information and the task type information, and transmit the response data to the terminal and repeatedly perform a process of accepting input of a new prompt sentence that enables continuation of interaction with the user.

### (Supplementary 2)

The system according to supplementary 1,
wherein the processor is configured to
use the natural language processing program and the generative artificial intelligence model to generate an internal prompt sentence for determining classification of the prompt sentence, estimation of the task type, and constraint conditions of length, language, style, and format of an output sentence, and automatically update the task type information and the processing condition information on the basis of a result obtained from the internal prompt sentence.

### (Supplementary 3)

The system according to supplementary 1,
wherein the processor is configured to
when the selected processing target includes a plurality of electronic devices or external functions, generate processing flow information indicating an execution order, cooperation relationship, and input and output formats of the processing targets, automatically supply first processing result data as input data to a second processing target in accordance with the processing flow information, and integrate a plurality of pieces of processing result data obtained by multistage processing into single response data to be transmitted to the terminal.

### Application Example 2

### (Supplementary 1)

A system comprising a processor,
wherein the processor is configured to
manage, in an integrated manner, a plurality of information processing resources and a plurality of external processing functions by using an information storage unit that records attribute information, processing performance information, and usage status information of the plurality of information processing resources and the plurality of external processing functions,
perform preprocessing on input information including a prompt sentence received from a terminal device by using a natural language processing technique so as to generate context information including morphological information, syntactic information, named expression information, and topic information,
classify a processing type of a user request on the basis of the context information and determine a processing route including at least one of an information retrieval process, a summarization process, an explanation generation process, a recommendation process, an image generation process, and an emotion-responsive process,
select, on the basis of the processing route and on the basis of the attribute information, the processing performance information, and the usage status information recorded in the information storage unit, at least one processing resource from among the plurality of information processing resources and the plurality of external processing functions,
construct, on the basis of the prompt sentence, the context information, and user attribute information, an internal prompt sentence to be input to a subordinate generative artificial intelligence model, and generate control information for transmitting the internal prompt sentence to the selected at least one processing resource,
collect a plurality of processing results obtained from at least one of the generative artificial intelligence model, a recommendation processing model, an image processing model, and an external business processing function, calculate a reliability index and an accuracy index for the plurality of processing results by using a statistical analysis technique and a trained evaluation model, and integrate the plurality of processing results to generate an integrated result,
estimate emotion state information from user input by performing voice recognition processing or text analysis processing, and adjust a style, a tone, and content of a response message on the basis of the emotion state information and the integrated result, and transmit the adjusted response message and the integrated result as output data to the terminal device.

### (Supplementary 2)

The system according to supplementary 1,
wherein the processor is configured to update, in the determination of the processing route and in the selection of the at least one processing resource for the prompt sentence, a selection policy of the processing resources and a configuration policy of the internal prompt sentence by using, as learning data, operation history information of a user and evaluation information regarding response results transmitted from the terminal device, and dynamically optimize the processing route and the processing resources for subsequent prompt sentences on the basis of the updated policies.

### (Supplementary 3)

The system according to supplementary 1,
wherein the processor is configured to select, in accordance with the emotion state information, at least one response function from among a complaint-handling dialogue function, a comfort-enhancement content provision function, and an explanation-oriented dialogue function included in a response function group, generate, by using a generative artificial intelligence model, the internal prompt sentence for the selected response function, and determine a final response by evaluating a response candidate generated on the basis of the internal prompt sentence together with the integrated result.

What is claimed is:

1. A system comprising:
circuitry configured to:
record, in an information storage element via a communication interface coupled to a packet-switched network, type information, processing capability information, usage state information, and operational performance information for each of a plurality of information processing elements and external function elements, and centrally manage the plurality of information processing elements and the external function elements based on the recorded information;
acquire text information of a prompt sentence from a user terminal via the communication interface, perform preprocessing comprising character code conversion, removal of unnecessary characters, and format normalization on the prompt sentence, analyze contextual information of the prompt sentence using a natural language processing technique, and extract requirement condition information comprising at least a task type, an output format, and a constraint condition;
calculate, for each of the plurality of information processing elements, a suitability index by performing weighted arithmetic on a processing speed index, an accuracy index, and a resource utilization index based on the requirement condition information and the recorded type information, processing capability information, and usage state information, and select at least one information processing element or external function element based on the suitability index;
transmit processing request information comprising the prompt sentence and the requirement condition information to the selected element, cause a generative AI model executed on the selected element to perform information processing, acquire one or more processing results, calculate a reliability index and an accuracy index for the processing results using a statistical technique or a machine learning technique, and generate an integrated result by selecting or integrating the processing results based on the indices; and
format the integrated result into a data structure and transmit the integrated result to the user terminal via the communication interface, and store history information associated with the prompt sentence, the requirement condition information, the selected element, and the integrated result in the information storage element.

2. The system according to claim 1, wherein the circuitry is configured to
retrain at least one of a task type discrimination model and a suitability index calculation model using the history information, and dynamically update weight coefficients used in the suitability index calculation based on the retrained model.

3. The system according to claim 2, wherein the circuitry is configured to
append operational performance information comprising time-varying processing time information, error occurrence information, and user evaluation information to the recorded information in the information storage element, and update the weight coefficients for the suitability index calculation based on the appended operational performance information.

4. The system according to claim 3, wherein the circuitry is configured to
perform validation on the acquired processing results comprising inspection of output format conformity, language type, and satisfaction of structural requirements prior to calculating the reliability index and the accuracy index.

5. The system according to claim 4, wherein the circuitry is configured to
compute the integrated result by applying at least one of Bayesian estimation, confidence score weighting, output aggregation, or a machine learning ensemble model to the validated processing results.

6. The system according to claim 1, wherein the circuitry is configured to
analyze an emotional state of a user through at least one of voice analysis and text analysis of data received from the user terminal, and adjust at least one of a response format, a detail level, or a tone of the integrated result based on the analyzed emotional state.

7. The system according to claim 6, wherein the circuitry is configured to
extract acoustic features from audio data received from the user terminal and apply a trained emotion classification model to the acoustic features to generate an emotion label, and select a response generation parameter based on the emotion label.

8. The system according to claim 7, wherein the circuitry is configured to
apply the trained emotion classification model to lexical features extracted from text data of the prompt sentence when audio data is unavailable, and generate the emotion label from the lexical features.

9. The system according to claim 1, wherein the natural language processing technique applied to the prompt sentence comprises tokenization, named entity recognition, and semantic role labeling to extract the task type and constraint condition as structured requirement condition information.

10. The system according to claim 1, wherein the suitability index for each information processing element is computed as a weighted sum of the processing speed index, the accuracy index, and the resource utilization index, wherein the weights are retrieved from the information storage element and updated based on historical performance data.

11. The system according to claim 1, wherein the information processing performed by the generative AI model comprises at least one of text generation processing, summarization processing, translation processing, question answering processing, and data analysis processing.

12. The system according to claim 1, wherein the external function elements are processing resources accessible over the communication interface, and wherein the circuitry is configured to transmit processing request information to the external function elements using standardized API calls over the communication interface.

13. The system according to claim 12, wherein the circuitry is configured to
monitor response latency and error rates for each external function element, and update the usage state information and operational performance information in the information storage element based on monitored metrics.

14. The system according to claim 1, wherein the circuitry is configured to
store the history information in an anonymous manner by removing user-identifiable attributes from the prompt sentence prior to storage in the information storage element.

15. The system according to claim 14, wherein the circuitry is configured to
aggregate the anonymized history information over a predetermined time window, compute performance statistics for each information processing element, and generate a performance report for presentation via the user terminal.

16. The system according to claim 1, wherein the circuitry is configured to
detect a change in the usage state information for any of the plurality of information processing elements, update the suitability index for the changed element in real time, and reselect the optimal information processing element if the updated suitability index changes the selection ranking.

17. The system according to claim 16, wherein the circuitry is configured to
generate an alert notification and transmit the alert notification to an operator terminal via the communication interface when the processing capability information for any of the plurality of information processing elements falls below a predetermined threshold.

18. A system comprising:
circuitry configured to:
maintain, in an information storage element, type information, processing capability information, usage state information, and operational performance information for each of a plurality of information processing elements and external function elements;
receive a prompt sentence from a user terminal via a communication interface, apply a natural language processing technique to extract requirement condition information comprising a task type and a constraint condition, calculate a suitability index for each information processing element based on the requirement condition information and the recorded information, and select at least one information processing element based on the suitability index;
cause a generative AI model on the selected element to process the prompt sentence, acquire processing results, evaluate reliability and accuracy of the processing results using a statistical technique or a machine learning technique, and generate an integrated result; and
transmit the integrated result to the user terminal and store history information in the information storage element, and retrain at least one model used in task type discrimination or suitability index calculation using the history information.

19. The system according to claim 18, wherein the circuitry is configured to
analyze an emotional state of a user from voice data or text data received from the user terminal, and adjust a response parameter of the integrated result based on the analyzed emotional state.

20. A method comprising:
recording, in an information storage element via a communication interface coupled to a packet-switched network, type information, processing capability information, usage state information, and operational performance information for each of a plurality of information processing elements and external function elements, and centrally managing the plurality of information processing elements and the external function elements based on the recorded information;
acquiring text information of a prompt sentence from a user terminal via the communication interface, performing preprocessing comprising character code conversion, removal of unnecessary characters, and format normalization on the prompt sentence, analyzing contextual information of the prompt sentence using a natural language processing technique, and extracting requirement condition information comprising at least a task type, an output format, and a constraint condition;
calculating, for each of the plurality of information processing elements, a suitability index by performing weighted arithmetic on a processing speed index, an accuracy index, and a resource utilization index based on the requirement condition information and the recorded type information, processing capability information, and usage state information, and selecting at least one information processing element or external function element based on the suitability index;
transmitting processing request information comprising the prompt sentence and the requirement condition information to the selected element, causing a generative AI model executed on the selected element to perform information processing, acquiring one or more processing results, calculating a reliability index and an accuracy index for the processing results using a statistical technique or a machine learning technique, and generating an integrated result by selecting or integrating the processing results based on the indices; and
formatting the integrated result into a data structure and transmitting the integrated result to the user terminal via the communication interface, and storing history information associated with the prompt sentence, the requirement condition information, the selected element, and the integrated result in the information storage element.
